(19) United States
(12) Patent Application Publication
(10) Pub. No.: US 2016/0274916 A1
(43) Pub. Date: Sep. 22, 2016

(54) PROCESSOR, PROGRAM CODE TRANSLATOR AND SOFTWARE

(71) Applicant: Renesas Electronics Corporation, Tokyo (JP)

(72) Inventor: Yuki KOBAYASHI, Tokyo (JP)

(21) Appl. No.: 15/056,952

(22) Filed: Feb. 29, 2016

(30) Foreign Application Priority Data
Mar. 18, 2015 (JP) 2015-054448

(51) Int. Cl. G06F 9/38; G06F 9/30

(52) U.S. Cl. CPC G06F 9/3867; G06F 9/30098; G06F 9/3016; G06F 9/3802

(57) ABSTRACT

Whether to prohibit or to permit forwarding (forwarding OFF/ON) is specified for every instruction, the forwarding is performed such that a register file is referred to when executing an instruction of which the forwarding is prohibited, and such that a pipeline stage at an intermediate of the pipeline which writes data in the register file is referred to when executing an instruction of which the forwarding is permitted. In particular, a field which specifies to prohibit or to permit the forwarding is provided for each of multiple instructions composing one word of a VLIW, and a forwarding control circuit and a forwarding selector are provided to control whether to refer to a register (to prohibit forwarding) or to perform the forwarding according to a value of the field concerned.

### CROSS-REFERENCE TO RELATED APPLICATIONS

The present application claims priority from Japanese Patent Application JP 2015-054448 filed on Mar. 18, 2015, the content of which is hereby incorporated by reference into this application.

### BACKGROUND

The present invention is related to a processor, a program code translator to generate a preferable program for the processor, and software to be executed by a computer to function as the program code translator. In particular, the present invention is preferable for use in a pipeline type VLIW (Very Long Instruction Word) processor.

In order to improve arithmetic performance, a processor which issues multiple instructions in parallel and utilizes an instruction word of a VLIW configuration is known. That is, the processor fetches, decodes and executes a single VLIW instruction, and a data path processes multiple operations included in the VLIW instruction.

A software pipelining technique is known as a speeding-up technique which utilizes the wide instruction issue width of a VLIW processor effectively. Generally, it is said that a small portion of loops occupy the vast majority of execution time of software, and the software pipelining is a technique of speeding up this loop. That is, by performing optimization in moving operation across plural repetitions of a loop, the number of the execution cycles per repetition is reduced.

### SUMMARY

As a performance bottleneck at the time of the software pipelining of a VLIW processor, it is pointed out that plural instances of a variable must be held. The software pipelining increases the number of parallel instructions issued in a loop and improves the performance. However, it is known that, when the software pipelining is advanced, namely, when the initiation interval is made small, the number of general-purpose registers in use increases and the number of registers becomes a bottleneck, hindering the improvement of the performance. One of the causes of the increase in the number of registers is use of a variable over multiple repetitions in a loop. That is, the causes stem from the necessity to hold multiple instances. However, it is not preferred to increase the number of registers to be implemented because it leads directly to the increase of hardware.

The following explains a solution to such a problem, and the other issues and new features of the present invention will become clear from the description of the present specification and the accompanying drawings.

One embodiment according to the present application goes as follow.

A processor to specify whether to permit or to prohibit forwarding for every instruction is provided. The processor refers to a register file, when executing an instruction of which the forwarding is prohibited, and refers to an intermediate stage of a pipeline which writes data into the register file, when executing an instruction of which the forwarding is permitted.

The effect obtained by one embodiment described above is explained briefly as follows.

That is, it is possible to make improvements in the performance by the software pipelining, without increasing the number of registers to be implemented in the register file.

### BRIEF DESCRIPTION OF THE DRAWINGS

FIG. 1 is a block diagram illustrating an example of the basic configuration of a processor which can specify ON/OFF of forwarding;

FIG. 2 is an explanatory drawing illustrating an example of the configuration of an instruction code to be executed by the processor illustrated in FIG. 1;

FIG. 3 is a block diagram illustrating an example of the configuration of a forwarding selector mounted in the processor illustrated in FIG. 1;

FIG. 4 is a flow chart illustrating an example of the function of a forwarding control circuit mounted in the processor illustrated in FIG. 1;

FIG. 5 is a block diagram illustrating an example of the configuration of a VLIW processor which can specify ON/OFF of the forwarding;

FIG. 6 is an explanatory drawing illustrating an example of the configuration of an instruction word to be executed by the processor illustrated in FIG. 5;

FIG. 7 is a block diagram illustrating an example of the configuration of a processor control circuit mounted in the processor illustrated in FIG. 5;

FIG. 8 is a block diagram illustrating an example of the configuration of a forwarding selector mounted in the processor illustrated in FIG. 5;

FIG. 9 is a flow chart illustrating an example of the function of a forwarding control circuit mounted in the processor illustrated in FIG. 5;

FIG. 10 is an explanatory drawing illustrating an example of a program described in a high level language, to be executed by the processor illustrated in FIG. 5;

FIG. 11 is an explanatory drawing illustrating an example of a program described in assembly language, to be executed by the processor illustrated in FIG. 5;

FIG. 12 is an explanatory drawing illustrating operation of an instruction described in assembly language used by the program illustrated in FIG. 11;

FIG. 13 is a timing chart illustrating schematically an example of operation of the processor illustrated in FIG. 5;

FIG. 14 is an explanatory drawing illustrating a program described in assembly language to be executed by the processor illustrated in FIG. 5, and illustrating an example in which ON/OFF of forwarding is not specified;

FIG. 15 is an explanatory drawing illustrating an example of operation of the processor illustrated in FIG. 5;

FIG. 16 is an explanatory drawing illustrating an example of the configuration of an instruction code to be executed by a processor according to Embodiment 2;

FIG. 17 is an explanatory drawing about a forwarding-source specifying information field in the instruction code illustrated in FIG. 16;

FIG. 18 is a flow chart illustrating an example of the function of a forwarding control circuit mounted in the processor according to Embodiment 2;

FIG. 19 is a flow chart illustrating an example of the function of a program development device according to Embodiment 3;

FIG. 20 is a schematic timing chart illustrating operation by a program before translation by a program code translator (optimizer); and

FIG. 21 is a schematic timing chart illustrating operation by a program after translation by the program code translator (optimizer).

### DETAILED DESCRIPTION

### 1. Outline of Embodiment

First, an outline of a typical embodiment disclosed in the present application is explained. A numerical symbol of the drawing referred to in parentheses in the outline explanation about the typical embodiment only illustrates what is included in the concept of the component to which the numerical symbol is attached.

(1) <A Processor Capable of Specifying ON/OFF of Forwarding>

A typical embodiment disclosed in the present application is a processor to specify whether to prohibit or to permit forwarding for every instruction. The processor refers to a register file (REGF), when executing an instruction of which the forwarding is prohibited, and refers to an intermediate stage of a pipeline which writes data in the register file, when executing an instruction of which the forwarding is permitted (to perform forwarding).

According to this configuration, it is possible to make improvements in the performance by the software pipelining, without increasing the number of registers to be implemented in the register file. This is because, after issuing an instruction to rewrite a register by an execution result before the write back of the instruction, it is possible to intermingle freely a forwarding-ON (forwarding permitted) instruction and a forwarding-OFF (forwarding prohibited and referring to a register file REGF) instruction.

(2) <An Instruction Including a Field to Specify ON/OFF of Forwarding>

In Paragraph 1, an instruction set executable by the processor includes an instruction of which an instruction code is provided with a field (f) to specify whether to permit or to prohibit the forwarding.

According to this configuration, it is possible to specify easily whether to prohibit or to permit the forwarding for every instruction.

(3) <A VLIW>

In the processor in paragraph 2, an instruction word (ICODE) comprised of an instruction code of multiple instructions included in the instruction set is issued in parallel, the instructions are executed in parallel, and the instruction word includes one or more instructions of which each instruction code is provided with a field to specify whether to permit or to prohibit the forwarding.

According to this configuration, in a VLIW processor in which one instruction word is comprised of multiple instructions, it is possible to make improvements in the performance by the software pipelining, without increasing the number of registers to be implemented in the register file. This is because it is possible to specify independently whether to prohibit or to permit the forwarding for every multiple instructions included in one instruction word of the VLIW.

(4) <An Instruction Including a Field to Specify a Forwarding Source>

In Paragraph 1, an instruction set executable by the processor includes an instruction of which an instruction code is provided with a field (fsrc) to specify whether to prohibit the forwarding or to permit the forwarding from which stage of the pipeline.

According to this configuration, it is not only possible whether to prohibit or to permit the forwarding simply, but it is also possible to specify which pipeline stage to be assigned as a forwarding source, when permitting; accordingly it is possible to enhance the degree of freedom. When the forwarding source is not specified, priority is given to the more previous forwarding, that is, the forwarding from the more distant pipeline stage from a write back stage.

(5) <A VLIW>

In the processor in paragraph 4, an instruction word (ICODE) comprised of an instruction code of multiple instructions included in the instruction set is issued in parallel, the multiple instructions are executed in parallel, and the instruction word includes one or more instructions of which each instruction code is provided with a field to specifies whether to prohibit the forwarding or to permit the forwarding from which stage of the pipeline.

According to this configuration, in a VLIW processor in which one instruction word is comprised of multiple instructions, it is possible to make further improvements in the performance by the software pipelining, without increasing the number of registers to be implemented in the register file. This is because it is possible to specify independently whether to prohibit or to permit the forwarding for every multiple instructions included in one instruction word of the VLIW, furthermore, it is also possible to freely specify which pipeline stage to be assigned as a forwarding source, when permitting.

(1) <A Processor Capable of Specifying ON/OFF of Forwarding>

A typical embodiment disclosed in the present application is a processor to execute, under a pipeline system, an instruction sequentially issued according to a program included in an instruction set. The processor is configured as follows.

The processor is comprised of a fetch circuit (IR) to fetch the instruction; a register file (REGF) including multiple registers; a forwarding selector (FSEL); a processing execution circuit (EXEC); and a processor control circuit (CTRL) to control the processing execution circuit on the basis of the instruction fetched.

The instruction set includes a register store instruction and a register reference instruction. The register store instruction is an instruction to store the result that the processing execution circuit has executed processing specified by the instruction concerned, into a register specified by a destination operand (rd) of the instruction concerned among the registers included in the register file. The register reference instruction is an instruction which makes the processing execution circuit execute processing specified by the instruction concerned, with reference to data stored in a register specified by a source operand (rs, rt) of the instruction concerned among the registers included in the register file. A part or all of the register reference instructions include afield (f) to specify whether to prohibit or to permit forwarding in an instruction code.

The processor control circuit is comprised of an instruction decoder (IDE) to decode the fetched instruction; multiple pipeline registers (OP-DE, OP-RR, FWD-DE, SRC-DE, DST-DE, DST-RR, and DST-EX) to hold a decoded result by the instruction decoder; and a forwarding control circuit (FWDCNT). The instruction decoder decodes the fetched instruction and outputs an execution code of the instruction. The instruction decoder outputs a destination operand code to specify a destination register when the instruction is the register store instruction. The instruction decoder outputs a source operand code to specify a source register when the instruction is the register reference instruction. The instruction decoder outputs a decoded result of the field concerned when the instruction is a register reference instruction including a field to specify whether to prohibit or to permit the forwarding in an instruction code. The pipeline registers hold the destination operand code for every pipeline stage (DST-DE, DST-RR, and DST-EX).

The forwarding control circuit controls the forwarding selector on the basis of a decoded result of a field to specify whether to prohibit or to permit the forwarding. When the forwarding is prohibited, the forwarding control circuit controls the forwarding selector to read a value of the register specified by the source operand code from the register file and to supply it to the processing execution circuit. When the forwarding is permitted, the forwarding control circuit compares the destination operand code held in the multiple pipeline registers for every pipeline stage with the source operand code, and controls the forwarding selector to execute the forwarding from a pipeline stage in agreement to the processing execution circuit.

According to this configuration, it is possible to make improvements in the performance by the software pipelining, without increasing the number of registers to be implemented in the register file. Here, the processing execution circuit (EXEC) may be an arithmetic operation circuit (ALU), a multiplier circuit (MUL), an arithmetic circuit such as a barrel shifter (SFT), a memory access circuit such as a load/store circuit, or a branch control circuit.

(7) <A VLIW>

In Paragraph 6, the processor is provided with N pieces of the processing execution circuit (N is an arbitrary natural number) (EXEC1-EXEC3), and can execute in parallel an instruction word including the N instructions included in the instruction set in one word by the corresponding processing execution circuit.

M processing execution circuits (EXEC1-EXEC3) out of the N processing execution circuits (M is an arbitrary natural numbers equal to or smaller than N) are coupled with forwarding selectors (FSEL-S1-FSEL-S3, FSEL-T1-FSEL-T3) of the number corresponding to each input number.

The instruction decoder decodes in parallel the N instructions included in the fetched instruction word, and outputs the corresponding decoded result to each of the N processing execution circuits. The decoded result corresponding to the M processing execution circuits includes the decoded result of the field to specify whether to prohibit or to permit the forwarding.

The processor control circuit is provided with M forwarding control circuits (FWDCNTS1-FWDCNTS3, FWDCNTT1-FWDCNTT3) corresponding to the M processing execution circuits, and each of the M forwarding control circuits executes the forwarding control to the corresponding processing execution circuit, on the basis of the decoded result of the field to specify whether to prohibit or to permit the forwarding.

According to this configuration, in a VLIW processor in which one instruction word is comprised of multiple instructions, it is possible to make improvements in the performance by the software pipelining, without increasing the number of registers to be implemented in the register file. This is because it is possible to specify independently whether to prohibit or to permit the forwarding for every multiple instructions included in one instruction word of the VLIW. The M processing execution circuits are slots in which the ON/OFF control of forwarding is possible, and the other N-M processing execution circuits are slots in which the ON/OFF control of forwarding is not adopted. When the ON/OFF control of forwarding is adopted in all slots, the degree of freedom enhances; however, the circuit scale increases. On the other hand, when the ON/OFF control of forwarding is adopted in a part (M pieces) of the slots, there arise restrictions that the instruction to perform the ON/OFF control of forwarding cannot be arranged in other slots than the slot concerned; however, the increase of the circuit scale can be suppressed.

Here, as is the case with Paragraph 6, the processing execution circuits (EXEC1-EXEC3) may be an arithmetic operation circuit (ALU), a multiplier circuit (MUL), an arithmetic circuit such as a barrel shifter (SFT), a memory access circuit such as a load/store circuit, or a branch control circuit. As for the processing execution circuits (EXEC1-EXEC3), a multifunctional processing execution circuit of which the function can be arbitrarily specified may be mounted in all the slots. Alternatively, a processing execution circuit with a simple function or a single function, as illustrated above, may be properly mounted in each slot. In the former configuration with a multifunctional processing execution circuit being mounted in all the slots, the circuit scale increases, however, the degree of freedom in programming becomes maximum. On the other hand, in the latter configuration, the degree of freedom in programming is restricted to some extent; however, the circuit scale can be suppressed small. As an intermediate option between them, it is also preferable to intermingle a multifunctional processing execution circuit and a processing execution circuit of a simple function or a single function.

(8) <Forwarding from the Other Slots>

In Paragraph 7, the processor control circuit holds the destination operand code corresponding to each of the N processing execution circuits for every pipeline stage in the pipeline registers (DST-DE1-DST-DE3, DST-RR1-DST-RR3, DST-EX1-DST-EX3).

The processor control circuit includes M forwarding control circuits (FWDCNTS1-FWDCNTS3, FWDCNTT1-FWDCNTT3) corresponding to the M processing execution circuits. On the basis of a decoded result of a field to specify whether to prohibit or to permit the forwarding, each of the M forwarding control circuits performs the following controls to one or more forwarding selectors (FSEL-S1-FSEL-S3, FSEL-T1-FSEL-T3) which are coupled to the corresponding processing execution circuit. When the forwarding is prohibited, the forwarding control circuit controls the one or more forwarding selectors to read a value of the register specified by the source operand code respectively corresponding to the one or more forwarding selectors from the register file and to supply it to the processing execution circuit concerned. When the forwarding is permitted, the forwarding control circuit compares the destination operand code corresponding to each of the N processing execution circuits held in the pipeline registers for every pipeline stage with the source operand code corresponding to the one or more forwarding selectors, respectively. The forwarding control circuit controls the forwarding selector concerned to execute the forwarding from a pipeline stage in agreement as the result to the processing execution circuit.

According to this configuration, it is possible to perform the forwarding also from the N-M slots which do not adopt the ON/OFF control of the forwarding.

(9) <An Instruction Including a Field to Specify a Forwarding Source>

In Paragraph 6, in place of or in addition to the part or all of the register reference instructions, a part or all of the register reference instructions include, in an instruction code, afield (fsrc) to specify a forwarding source to indicate whether to prohibit the forwarding or to permit the forwarding from which stage of the pipeline.

When the fetched instruction is a register reference instruction including a field to prohibit the forwarding or to specify the forwarding source in an instruction code, the instruction decoder further outputs the decoded result of the field concerned.

The forwarding control circuit controls the forwarding selector on the basis of the decoded result concerned. When the forwarding is prohibited, the forwarding control circuit controls the forwarding selector to read a value of the register specified by the source operand code from the register file and to supply it to the processing execution circuit. When the forwarding source is specified, the forwarding control circuit compares the destination operand code held in the specified pipeline stage of the pipeline registers with the source operand code, and controls the forwarding selector to execute the forwarding from a pipeline register in agreement to the processing execution circuit.

According to this configuration, as is the case with Paragraph 4, it is not only possible whether to prohibit or to permit the forwarding simply, but it is also possible to specify which pipeline stage to be assigned as a forwarding source, when permitting; accordingly it is possible to enhance the degree of freedom.

(10) <A VLIW>

In Paragraph 9, the processor is provided with N pieces of the processing execution circuit (N is an arbitrary natural number) (EXEC1-EXEC3), and can execute in parallel an instruction word including the N instructions included in the instruction set in one word by the corresponding processing execution circuit.

M processing execution circuits (EXEC1-EXEC3) out of the N processing execution circuits (M is an arbitrary natural number equal to or smaller than N) are coupled with forwarding selectors (FSEL-S1-FSEL-S3, FSEL-T1-FSEL-T3) of the number corresponding to each input number.

The instruction decoder decodes in parallel the N instructions included in the fetched instruction word and outputs the corresponding decoded result to each of the N processing execution circuits. The decoded result corresponding to the M processing execution circuits includes at least one of the decoded result of the field to specify whether to prohibit or to permit the forwarding and the decoded result of the field to prohibit the forwarding or to specify the forwarding source.

The processor control circuit is provided with M forwarding control circuits (FWDCNTS1-FWDCNTS3, FWDCNTT1-FWDCNTT3) corresponding to the M processing execution circuits, and each of the M forwarding control circuits executes the forwarding control to the corresponding processing execution circuit on the basis of the decoded result.

According to this configuration, as is the case with Paragraph 7, in a VLIW processor in which one instruction word is comprised of multiple instructions, it is possible to make improvements in the performance by the software pipelining, without increasing the number of registers to be implemented in the register file. Furthermore, as is the case with Paragraph 4 and Paragraph 9, it is not only possible whether to prohibit or to permit the forwarding simply, but it is also possible to specify which pipeline stage to be assigned as a forwarding source, when permitting; accordingly it is possible to enhance the degree of freedom.

(11) <Forwarding from Other Slots>

In Paragraph 10, the processor control circuit holds the destination operand code corresponding to each of the N processing execution circuits in the pipeline registers for every pipeline stage (DST-DE1-DST-DE3, DST-RR1-DST-RR3, DST-EX1-DST-EX3).

The processor control circuit includes M forwarding control circuits (FWDCNTS1-FWDCNTS3, FWDCNTT1-FWDCNTT3) corresponding to the M processing execution circuits. On the basis of the decoded result of the field to prohibit or to permit the forwarding or to specify the forwarding source, each of the M forwarding control circuits performs the following controls to one or more forwarding selectors (FSEL-S1-FSEL-S3, FSEL-T1-FSEL-T3) coupled to the corresponding processing execution circuit.

When the forwarding is prohibited, the forwarding control circuit controls one or more forwarding selectors to read a value of the register specified by the source operand code respectively corresponding to the one or more forwarding selectors from the register file and to supply it to the processing execution circuit concerned.

When the forwarding is permitted, the forwarding control circuit compares the destination operand code corresponding to each of the N processing execution circuits held in the pipeline registers for every pipeline stage with the source operand code corresponding to the one or more forwarding selectors, respectively. The forwarding control circuit controls the forwarding selector concerned to execute the forwarding from a pipeline register in agreement as the result to the processing execution circuit.

When the forwarding source is specified, each of the M forwarding control circuits compares the destination operand code held in the pipeline register of the pipeline stage of which the forwarding source is specified, among the destination operand codes held for every pipeline stage corresponding to the N processing execution circuits, with the source operand code corresponding to the forwarding selector, respectively. The forwarding control circuit controls the forwarding selector concerned to execute the forwarding from a pipeline register in agreement as the result to the processing execution circuit.

According to this configuration, it is possible to perform the forwarding also from the N-M slots which do not adopt the ON/OFF control of the forwarding.

(12) <An LSI (Large Scale Integrated Circuit)>

In one of Paragraph 6 to Paragraph 11, the processor is formed on a single semiconductor substrate.

According to this configuration, the processor is integrated on the single semiconductor chip and amounting area, power consumption and cost are reduced.

(13) <A Program Code Translator (Optimizer)>

A typical embodiment disclosed in the present application is a program code translator to convert the program code of a program which is comprised of multiple instructions included in an instruction set and executed by the processor. The program code translator is configured as follows.

The processor is comprised of a register file (REGF) comprised of multiple registers, and a processing execution circuit (EXEC). The processor is comprised of a pipeline including a register read step (RR) which refers to the register file, and a write back step (WB) which writes a value into the register file.

The instruction set includes a register reference instruction, a register store instruction, and a register move instruction.

The register reference instruction is an instruction to refer to a value stored in a register specified by a source operand of the instruction concerned, among multiple registers included in the register file in the register read step, and to make the processor execute processing specified by the instruction concerned.

The register store instruction is an instruction to store the result that the processor has executed the processing specified by the instruction concerned to a register specified by a destination operand of the instruction concerned among multiple registers included in the register file, in the write back step delayed from the register read step by a delaying amount (D_{A}) specified in terms of the number of stages of the pipeline.

The register move instruction is an instruction to read a value stored in a register specified by a source operand of the instruction concerned among multiple registers included in the register file in the register read step, and to write the value into a register specified by a destination operand of the instruction concerned in the write back step.

All or a part of the register reference instructions further include in an operand a forwarding invalid flag (f) to specify whether to prohibit or to permit forwarding. When the forwarding is prohibited by the forwarding invalid flag, the processor controls the register read step to refer the register file. When the forwarding is permitted by the forwarding invalid flag, the processor executes the register store instruction or the register move instruction and refers to a value stored into a register specified by the source operand from an intermediate stage of a pipeline which writes data into a register specified by the destination operand.

The program code translator is configured so as to execute each of the following steps.

The program code translator searches for a register move instruction (M) from the program code comprised of multiple instructions included in the instruction set (S4).

The program code translator extracts a register store instruction (A) to specify by a destination operand a register specified by a source operand (RS_{M}) of the register move instruction found by the search (S5). The program code translator replaces the subsequent register reference instruction (X) which specifies by a source operand the register specified by the destination operand (RD_{M}) of the register move instruction found by the search, with the register reference instruction which has specified to prohibit the forwarding based on a forwarding invalid flag, when executed in an execution step within the delaying amount (D_{A}) from the register store instruction (S7).

According to this configuration, in the program to be executed by the processor specified in Paragraph 1-Paragraph 12, it is possible to attain the optimization for aiming at the performance improvement by the software pipelining.

(14) <Move of an Instruction to a Step Capable of Forwarding>

In Paragraph 13, the program code translator executes the following processing about the subsequent register reference instruction (X) which specifies by a source operand the register specified by a destination operand of the register move instruction found by the search. When executed in an execution step behind the delaying amount (D_{A}) from the register store instruction, after determining whether it is possible to be moved to an execution step to be executed within the delaying amount and having been moved when it is possible, the program code translator replaces the register reference instruction (X) with a register reference instruction which has specified to permit the forwarding based on a forwarding invalid flag (S7).

According to this configuration, it is possible to utilize the forwarding more effectively and to make further improvements in the performance.

(15) <Deletion of a Register Move Instruction>

In Paragraph 14, the program code translator replaces all the subsequent register reference instructions which specify by a source operand the register specified by the destination operand of the register move instruction found by the search, with the register reference instruction which has specified to prohibit the forwarding based on a forwarding invalid flag, when executed in an execution step behind the delaying amount from the register store instruction, after determining whether it is possible to be moved to an execution step to be executed within the delaying amount and having been moved when it is possible (S7). The program code translator deletes the register move instruction found by the search from the program when all the register reference instructions have been moved to the execution step to be executed within the delaying amount (S8).

According to this configuration, it is possible to utilize the forwarding more effectively and to make further improvements in the performance.

(16) <A VLIW>

In one of Paragraph 13 to Paragraph 15, the processor is provided with N pieces of the processing execution circuit (EXEC1-EXEC3) (N is an arbitrary natural number), and can execute in parallel an instruction word including the N instructions included in the instruction set in one word by the corresponding processing execution circuit.

According to this configuration, in a VLIW processor in which one instruction word is comprised of multiple instructions, it is possible to utilize the forwarding more effectively and to make further improvements in the performance.

(17) <A Compiler>

In one of Paragraph 13 to Paragraph 16, the program code translator generates the program code comprised of multiple instructions included in the instruction set, from a program described in a high level language.

According to this configuration, it is possible to provide the compiler which can produce the effect obtained in Paragraph 13-Paragraph 16.

(18) <Program Code Translation (Optimization) Software>

The typical embodiment disclosed in the present application is software to function as the program code translator described in one of Paragraph 13 to Paragraph 17, when executed by a computer.

According to this, it is possible to provide the software for realizing the program code translator (optimizer) which can produce the effect obtained in Paragraph 13-Paragraph 17.

### 2. Details of Embodiment

The embodiment is further explained in full detail.

### Embodiment 1

### A Processor Capable of Specifying ON/OFF of Forwarding

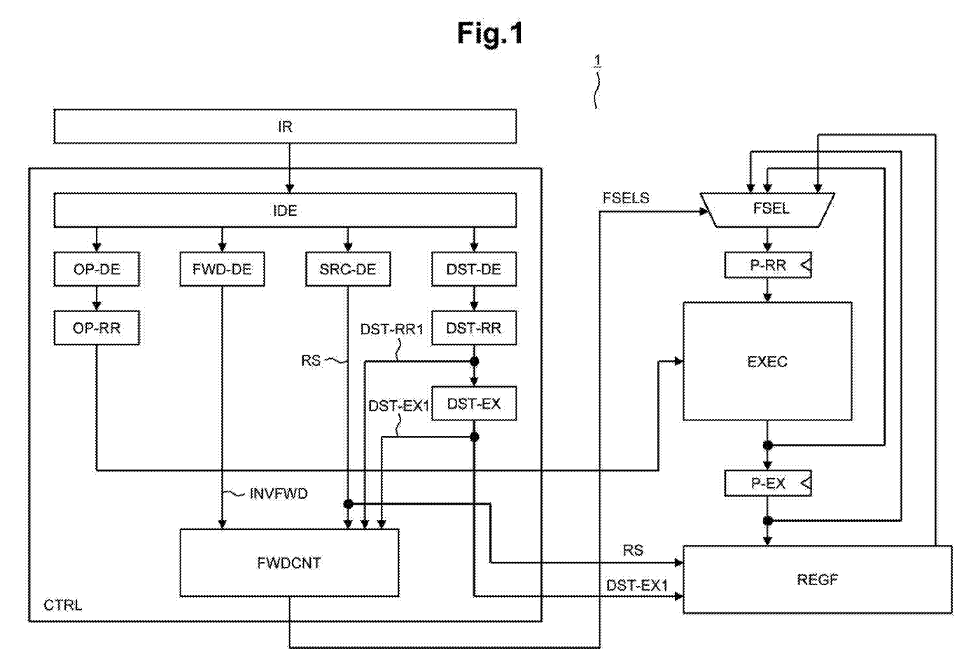

FIG. 1 is a block diagram illustrating an example of the basic configuration of a processor which can specify ON/OFF of forwarding for every instruction. A processor 1 according to Embodiment 1 is comprised of a fetch circuit IR, a register file REGF, a forwarding selector FSEL, a processing execution circuit EXEC, and a processor control circuit CTRL which controls the processing execution circuit EXEC on the basis of the fetched instruction. The processing execution circuit EXEC is, for example, an arithmetic operation circuit ALU, a multiplier circuit MUL, an arithmetic circuit such as a barrel shifter SFT, a memory access circuit such as a load/store circuit, or a branch control circuit. It is also preferable to implement a multifunctional circuit capable of executing various kinds of processing, as the processing execution circuit EXEC, and to configure it so as to execute one of the processing specified by an instruction code. The processor 1 may be comprised of (not shown) a nonvolatile memory mainly functioning as an instruction memory, an RAM (Random Access Memory) mainly functioning as a data memory or a work memory, an interrupt control circuit, a direct memory controller, a peripheral module, and a bus coupling them mutually. Although not restricted in particular, these circuits are formed on the single semiconductor substrate, such as silicon, by employing, for example, the well-known manufacturing technology of a CMOS (Complementary Metal-Oxide-Semiconductor field effect transistor) LSI. The processor 1 is integrated on the single semiconductor chip and a mounting area, power consumption and cost are reduced. It is also preferable to include several sets of core parts of the processor illustrated in the figure. In the block diagram illustrated in FIG. 1, bus wiring comprised of a large number of signal wiring is included in wiring among the blocks. However, the bus description is omitted in the notation. This point is similarly applied to the block diagrams described in other drawings referred to by the present description.

The instruction set of instructions executed by the processor 1 includes a register reference instruction and a register store instruction. The register reference instruction is an instruction to read data from the register file REGF in execution of an instruction, and includes a source operand. Besides an arithmetic instruction, a load instruction and a branch instruction to refer to a register are included. The register store instruction is an instruction to store (to write) in the register file REGF the result of having executed an instruction, and includes a destination operand. Besides an arithmetic instruction or a store instruction, instructions accompanied by updating by a post-increment or a pre-increment of a register value among a register indirect branch instruction are included.

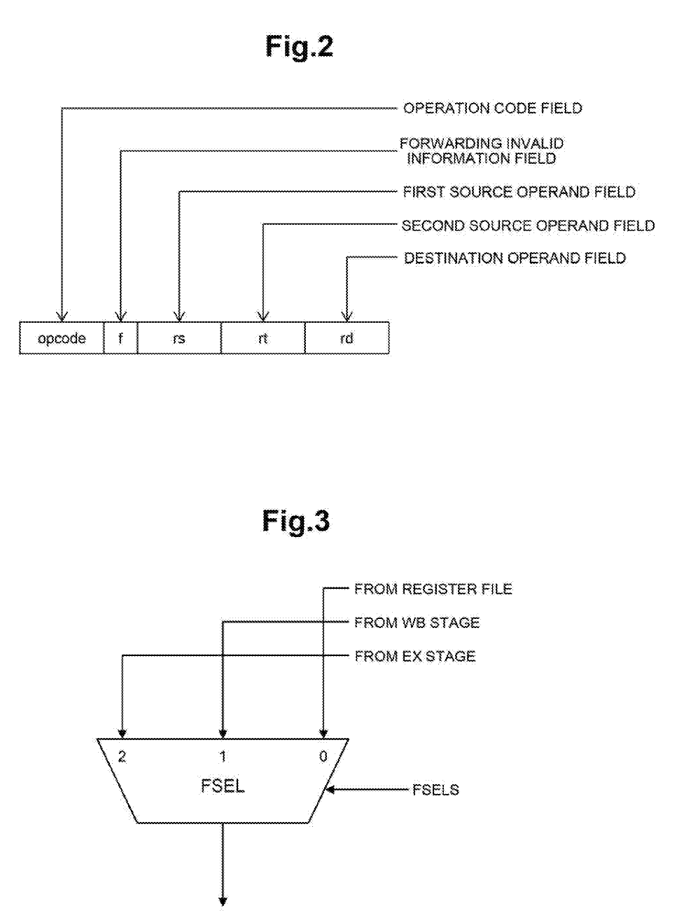

FIG. 2 is an explanatory drawing illustrating an example of the configuration of an instruction code to be executed by the processor illustrated in FIG. 1. An instruction code includes an operation code field opcode, a forwarding invalid information field f, a first source operand field rs, a second source operand field rt, and a destination operand field rd. The operation code field opcode is a field to specify the processing which the processing execution circuit EXEC is made to execute by the instruction concerned. The forwarding invalid information field f is a field to specify whether to prohibit or to permit forwarding (forwarding OFF/ON). The first source operand field rs and the second source operand field rt are operands to specify a register name or a register number in which data to be inputted from the register file REGF is stored, for the processing which the processing execution circuit EXEC is made to execute by the instruction concerned. The destination operand field rd is an operand to specify a register name or a register number of the register file REGF in which the processing result is to be stored. In addition to the instruction with two source operands and the instruction with one destination operand as described above, the instruction set of the processor 1 may include an instruction with no source operand and an instruction with three or more source operands, and an instruction with no destination operand and an instruction with two or more destination operands. The instruction including at least one source operand may further include a forwarding invalid information field f. As illustrated in FIG. 2, the instruction including both a source operand and a destination operand is classified to the above-described register reference instruction and at the same time it is classified to a register store instruction.

Returning to FIG. 1, the explanation is continued.

The processor 1 performs a pipeline operation. FIG. 1 illustrates an example in which the processor 1 is comprised of a four-step pipeline of a decode (DE) stage, a register read (RR) stage, an execution (EX) stage, and a write back (WB) stage. However, the number of pipeline stages can be changed arbitrarily. The processor 1 illustrated in FIG. 1 includes pipeline registers P-RR and P-EX. The pipeline register P-RR is a register holding data read from the register file REGF in the register read (RR) stage of a pipeline. The pipeline register P-EX is a register holding data outputted from the processing execution circuit EXEC in the execution (EX) stage of the pipeline. The data read from the register file REGF, the data outputted from the processing execution circuit EXEC, and the data outputted from the pipeline register P-EX are inputted into the forwarding selector FSEL, and one of them is selected and supplied to the pipeline register P-RR as a result of control by the processor control circuit CTRL. The forwarding is an operation in which the output from the processing execution circuit EXEC by another preceding instruction is inputted into the pipeline register P-RR, in the step where the output is held in a pipeline stage previous to being written in the register file REGF in the write back (WB) stage, and in the register read (RR) stage of the subsequent instruction which requires the data of the output. When the forwarding is prohibited as a result of the control by the processor control circuit CTRL, the forwarding selector FSEL illustrated in FIG. 1 inputs the data read from the register file REGF into the pipeline register P-RR in the register read (RR) stage. When the forwarding is permitted, on the other hand, the forwarding selector FSEL inputs the data outputted from the processing execution circuit EXEC in the register read (RR) stage or the data outputted from the pipeline register P-EX in the execution (EX) stage, into the pipeline register P-RR. The details thereof will be described below.

The processor control circuit CTRL includes an instruction decoder IDE which decodes the fetched instruction, multiple pipeline registers OP-DE, OP-RR, FWD-DE, SRC-DE, DST-DE, DST-RR, and DST-EX, which hold the decoded result by the instruction decoder IDE, and a forwarding control circuit FWDCNT.

The instruction decoder IDE decodes the fetched instruction and outputs an execution code of an instruction. The execution code outputted includes, for example, an operation code, forwarding invalid information, a source operand code, and a destination operand code. The pipeline registers OP-DE and OP-RR hold an operation code in the decode (DE) stage and the register read (RR) stage, respectively. The pipeline register FWD-DE holds forwarding invalid information INVFWD in the decode (DE) stage. The pipeline register SRC-DE holds a source operand code RS in the decode (DE) stage. The pipeline registers DST-DE, DST-RR, and DST-EX hold a destination operand code for each pipeline stage of the decode (DE) stage, the register read (RR) stage, and the execution (EX) stage. The operation code held in the pipeline register OP-RR is supplied to the processing execution circuit EXEC, and controls the contents of the processing by the processing execution circuit EXEC in the next execution (EX) stage. The source operand code RS held in the pipeline register SRC-DE is supplied to the register file REGF, and data is read from a register of the register name (or register number) specified by the source operand code in the register read (RR) stage, and supplied to the pipeline register of the register read (RR) stage via the forwarding selector FSEL. The destination operand code DST-EX1 held in the pipeline register DST-EX is supplied to the register file REGF and the execution result of the processing execution circuit EXEC is written to a register of the register name (or register number) specified by the destination operand code DST-EX1 in the write back (WB) stage.

The forwarding control circuit FWDCNT controls the forwarding selector FSEL on the basis of the decoded result of the field f to specify whether to prohibit or to permit the forwarding. When the forwarding is prohibited, the forwarding control circuit FWDCNT controls the forwarding selector FSEL to read the value of the register specified by the source operand code from the register file REGF, to supply it to the processing execution circuit EXEC. When the forwarding is permitted, the forwarding control circuit FWDCNT compares the destination operand code held in the pipeline registers DST-DE, DST-RR, and DST-EX for every pipeline stage with the source operand code held in the pipeline register SRC-DE. When there is a code in agreement, the forwarding from a pipeline stage in agreement to the processing execution circuit EXEC is performed. That is, without waiting for the write back (WB) to the register file REGF, the value of intermediate step of a pipeline (the output value of the processing execution circuit EXEC itself, and the value of the pipeline register P-EX) is supplied to the pipeline register P-RR of the processing execution circuit EXEC via the forwarding selector FSEL.

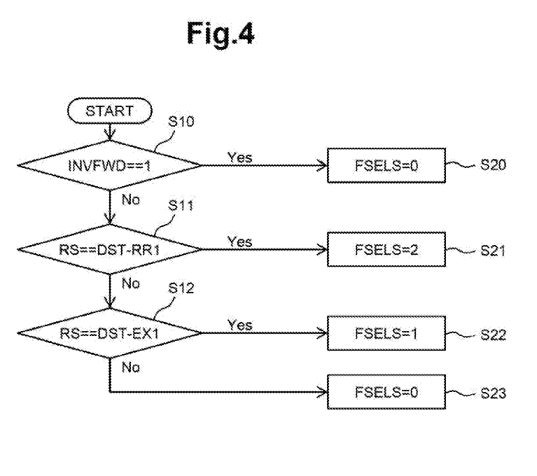

FIG. 3 is a block diagram illustrating an example of the configuration of a forwarding selector FSEL mounted in the processor 1, and FIG. 4 is a flowchart illustrating an example of the function of the forwarding control circuit FWDCNT. The forwarding selector FSEL is supplied with the data read from the register file REGF, the data from the write back (WB) stage of the processing execution circuit EXEC (the output of the pipeline register P-EX), and the data from the execution (EX) stage of the processing execution circuit EXEC (the output value of the processing execution circuit EXEC itself). On the basis of the selection control signal FSELS supplied from the forwarding control circuit FWDCNT, the forwarding selector FSEL selects one of the data inputted, and writes it in the pipeline register P-RR of the processing execution circuit EXEC. When the forwarding invalid information INVFWD is 1 (S10), that is, when the forwarding is prohibited, the forwarding control circuit FWDCNT sets the selection control signal as FSELS=0 (S20) and controls the forwarding selector FSEL to select the data read from the register file REGF and to write it in the pipeline register P-RR. When the forwarding invalid information INVFWD is 0 (S10), that is, when the forwarding is permitted, the forwarding control circuit FWDCNT compares the source operand code RS with DST-RR1 held in the pipeline register DST-RR (S11), and sets the selection control signal as FSELS=2 when they are in agreement (S21). When they are in disagreement, the forwarding control circuit FWDCNT compares the source operand code RS with DST-EX1 held next at the pipeline register DST-EX (S12), and sets the selection control signal as FSELS=1 when they are in agreement (S22). Furthermore, when they are in disagreement, the forwarding control circuit FWDCNT sets the selection control signal as FSELS=0 (S23). It should be noted that the meaning of the numerical value assigned to the forwarding invalid information INVFWD or the selection control signal FSELS is arbitrary, and what is illustrated here is only an example.

According to this configuration, it is possible to make improvements in the performance by the software pipelining, without increasing the number of registers to be implemented in the register file REGF.

<A VLIW Processor>

It is more suitable when the embodiment described so far is applied to a VLIW processor.

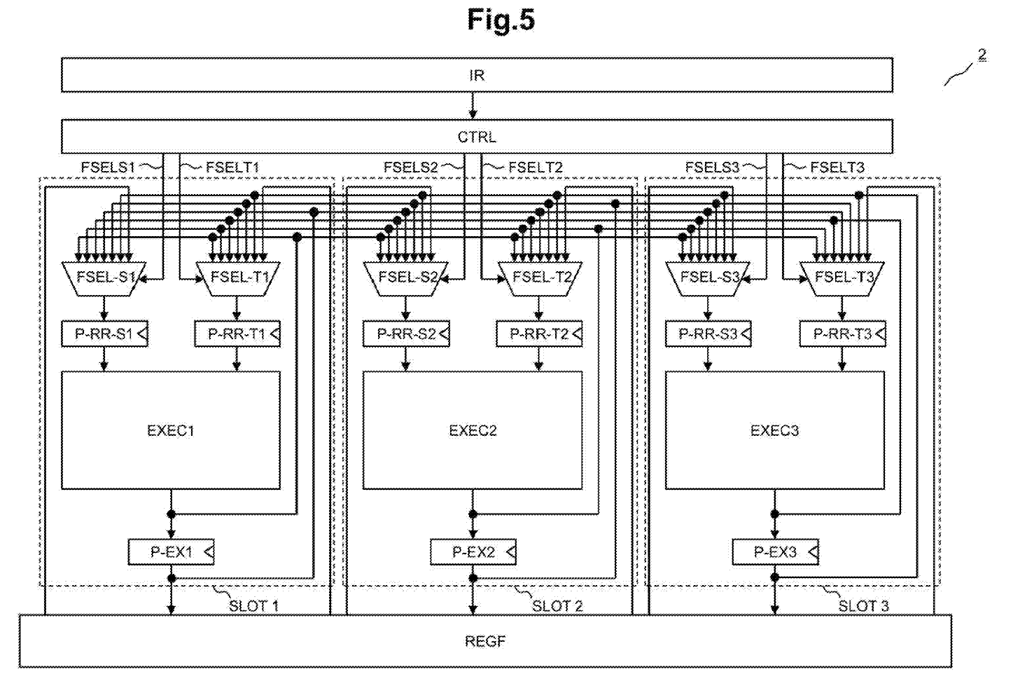

FIG. 5 is a block diagram illustrating an example of the configuration of a processor by VLIW which can specify ON/OFF of the forwarding for every instruction. The VLIW processor 2 includes a fetch circuit IR, a processor control circuit CTRL, three-slot processing execution circuits EXEC1-EXEC3, and a register file REGF. The processing execution circuits EXEC1-EXEC3 include every two forwarding selectors FSEL-S1 and FSEL-T1, FSEL-S2 and FSEL-T2, and FSEL-S3 and FSEL-T3 at the input section, respectively. In order to configure a pipeline, the processing execution circuits EXEC1-EXEC3 include every two pipeline registers P-RR-S1 and P-RR-T1, P-RR-S2 and P-RR-T2, and P-RR-S3 and P-RR-T3 at the input section, respectively, and pipeline registers P-EX1, P-EX2, and P-EX3 at the output section. The processing execution circuits EXEC1-EXEC3 are, for example, an arithmetic operation circuit ALU, a multiplier circuit MUL, an arithmetic circuit such as a barrel shifter SFT, a memory access circuit such as a load/store circuit, or a branch control circuit. It is also preferable to implement a multifunctional circuit capable of executing various kinds of processing, and to configure it so as to execute one of the processing specified by an instruction code. It is preferable to arrange a processing execution circuit capable of executing all the functions at all the three slots, or to properly arrange at each slot a processing execution circuit with the single function or with the function restricted in executable kinds. When the processing execution circuit capable of executing all the functions is arranged at all the three slots, the circuit scale becomes large, however, the kind of executable instruction becomes arbitrary independent of a slot. Accordingly, the degree of freedom of programming becomes high, and it becomes possible to suppress the number of steps necessary for the processing. On the other hand, when a processing execution circuit with the single function or with the function restricted in executable kinds is properly arranged at each slot, the circuit scale can be suppressed. FIG. 5 illustrates an example of three slots; however, the number of slots is arbitrary. The VLIW processor 2 may be comprised of (not shown) a nonvolatile memory mainly functioning as an instruction memory, an RAM functioning as a data memory or a work memory, an interrupt control circuit, a direct memory controller, a peripheral module, and a bus coupling them mutually. Although not restricted in particular, these circuits are formed on the single semiconductor substrate, such as silicon, by employing the well-known manufacturing technology of a CMOS LSI, for example. The VLIW processor 2 is integrated on the single semiconductor chip and a mounting area, power consumption and cost are reduced.

The fetch circuit IR fetches a long instruction word (VLIW) which includes three instruction codes in one word, and supplies three instructions to the processor control circuit CTRL in parallel. The processor control circuit CTRL decodes the supplied three instructions in parallel, and makes the three-slot processing execution circuits EXEC1-EXEC3 operate in parallel. The operation of the processing execution circuits EXEC1-EXEC3 and the pipeline registers respectively coupled thereto is the same as that explained with reference to FIG. 1. Therefore, the explanation thereof is omitted. The control signal of the processing execution circuits EXEC1-EXEC3 and the read and write control signal of the register file REGF are the same as those of FIG. 1, and the drawing thereof is omitted in FIG. 5.

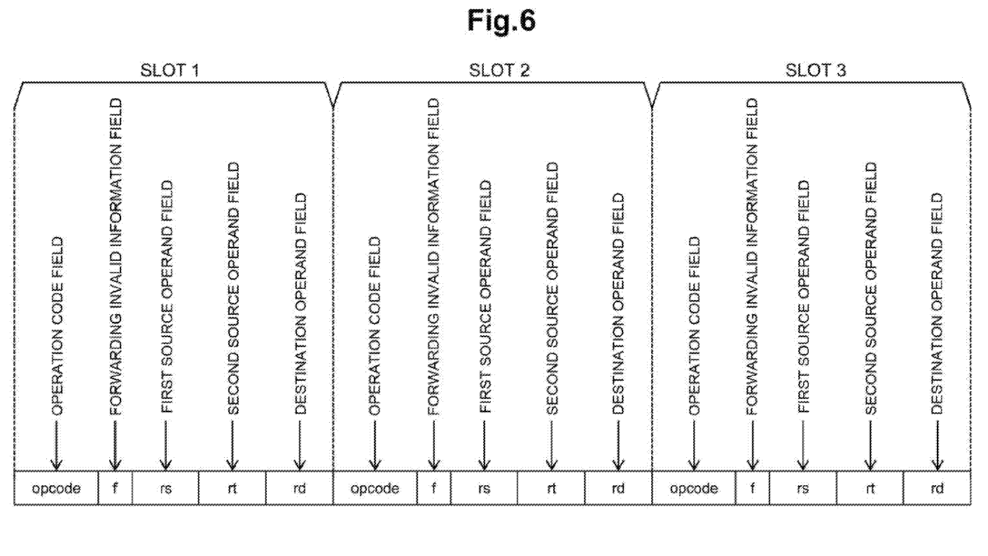

FIG. 6 is an explanatory drawing illustrating an example of the configuration of an instruction word executed by the VLIW processor 2. The instruction word executed by the VLIW processor 2 is a long instruction word which includes multiple instruction codes in one word, and includes three instruction codes corresponding to the slots 1-3, respectively. Each instruction code is specified in accordance with the processing which can be executed by the processing execution circuits EXEC1-EXEC3 to be implemented. FIG. 5 illustrates an example in which all the processing execution circuits EXEC1-EXEC3 at the slots 1-3 have two register inputs, one register output, and the forwarding ON/OFF function, respectively. Three instruction codes corresponding to the slots 1-3 include, respectively, an operation code field opcode, a forwarding invalid information field f, a first source operand field rs, a second source operand field rt, and a destination operand field rd.

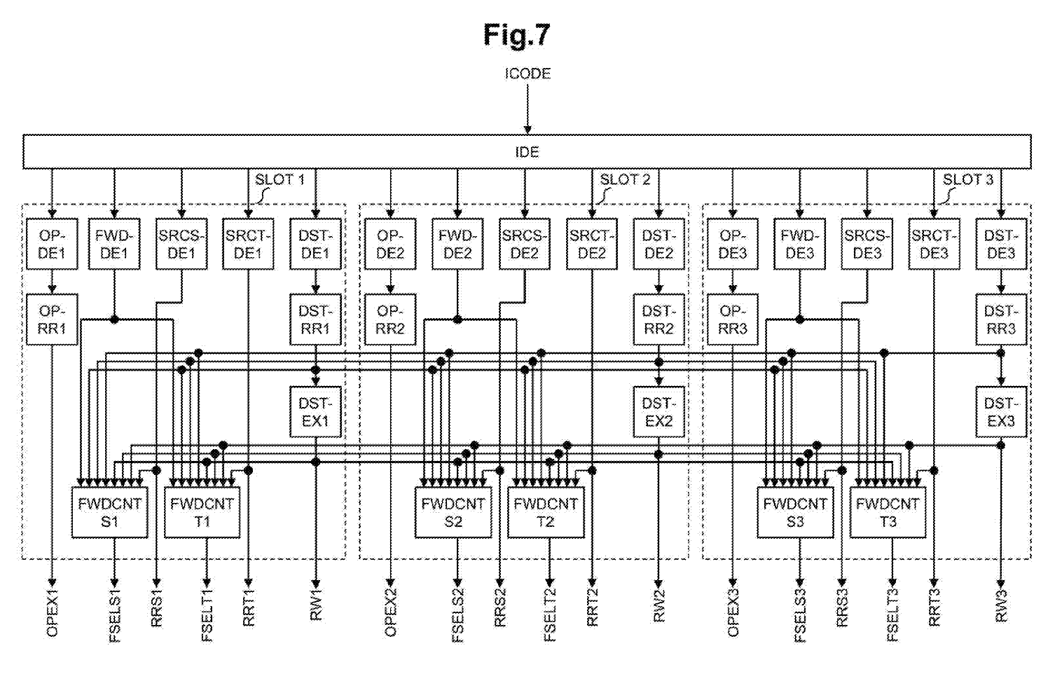

FIG. 7 is a block diagram illustrating an example of the configuration of a processor control circuit CNTL mounted in the VLIW processor 2. The processor control circuit CTRL includes an instruction decoder IDE which decodes the fetched instruction, multiple pipeline registers which hold the decoded result corresponding to each slot by the instruction decoder IDE, respectively, and multiple forwarding control circuits. Every two forwarding control circuits are provided in each slot, corresponding to the number of source operands. That is, corresponding to the slot 1, the pipeline registers OP-DE1, OP-RR1, FWD-DE1, SRCS-DE1, SRCT-DE1, DST-DE1, DST-RR1, and DST-EX1, and the forwarding control circuits FWDCNT-S1 and FWDCNT-T1 are provided. Corresponding to the slot 2, the pipeline registers OP-DE2, OP-RR2, FWD-DE2, SRCS-DE2, SRCT-DE2, DST-DE2, DST-RR2, and DST-EX2, and the forwarding control circuits FWDCNT-S2 and FWDCNT-T2 are provided. Corresponding to the slot 3, the pipeline registers OP-DE3, OP-RR3, FWD-DE3, SRCS-DE3, SRCT-DE3, DST-DE3, DST-RR3, and DST-EX3, and the forwarding control circuits FWDCNT-S3 and FWDCNT-T3 are provided.

The instruction decoder IDE decodes the fetched instruction and outputs the operation code, the forwarding invalid information, a source operand code, and a destination operand code, corresponding to each slot. The pipeline registers OP-DE1-OP-DE3 and OP-RR1-OP-RR3 hold the operation code in each slot in the decode (DE) stage and the register read (RR) stage, respectively. The pipeline registers FWD-DE1-FWD-DE3 hold the forwarding invalid information INVFWD1-INVFWD3 in each slot in the decode (DE) stage. SRCS-DE1-SRCS-DE3 and SRCT-DE1-SRCT-DE3 hold source operand codes RS and RT in each slot in the decode (DE) stage, respectively. The pipeline registers DST-DE1-DST-DE3, DST-RR1-DST-RR3, and DST-EX1-DST-EX3 hold the destination operand code in each slot, for every pipeline stage of the decode (DE) stage, the register read (RR) stage, and the execution (EX) stage. The operation code held at the pipeline registers OP-RR1-OP-RR3 is supplied to the processing execution circuits EXEC1-EXEC3, respectively as the control signals OPEX1-OPEX3 for controlling the contents of the processing by the processing execution circuits EXEC-EXEC3 in the next execution (EX) stage. The source operand codes RS1-RS3 held at the pipeline registers SRCS-DE1-SRCS-DE3 and the source operand codes RT1-RT3 held at the SRCT-DE1-SRCT-DE3 are supplied to the register file REGF as the control signals RRS1-RRS3 and RRT1-RRT3 for specifying the register name (or register number) of the read object, respectively. The destination operand codes DST-EX1-DST-EX3 held at the pipeline registers DST-EX1-DST-EX3 are supplied to the register file REGF as the control signals RW1-RW3 for controlling the write in the write back (WB) stage of the execution result of the processing execution circuits EXEC1-EXEC3.

The forwarding control circuits FWDCNTS1-FWDCNTS3, and FWDCNTT1-FWDCNTT3 are provided in the slots 1-3, corresponding to the source operands rs and rt, respectively, and control the forwarding selectors FSEL-S1-FSEL-S3, and FSEL-T1-FSEL-T3, on the basis of the decoded result of the field f to specify whether to prohibit or to permit the forwarding. When the forwarding is prohibited, the forwarding control circuits FWDCNTS1-FWDCNTS3, and FWDCNTT1-FWDCNTT3 control the forwarding selectors FSEL-S1-FSEL-S3, and FSEL-T1-FSEL-T3 to read the value of the register specified by the source operand code from the register file REGF, and to supply it to the processing execution circuits EXEC1-EXEC3. When the forwarding is permitted, the forwarding control circuits FWDCNTS1-DCNTS3, and FWDCNTT1-DCNTT3 compare the source operand code held at the SRCS-DE1-SRCS-DE3 and the SRCT-DE1-SRCT-DE3, respectively, with the destination operand code of each pipeline stage of the slots 1-3 held at the DST-RR1-DST-RR3 and DST-EX1-DST-EX3, respectively. When there is a code in agreement, the forwarding from the pipeline stage of a slot in agreement to the corresponding source input of the processing execution circuit is performed via the corresponding forwarding selector.

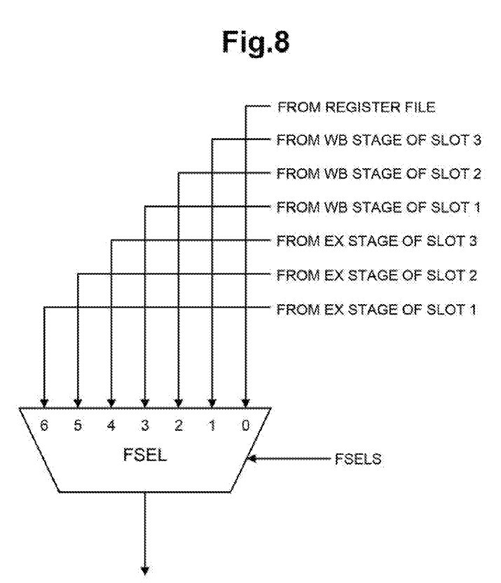

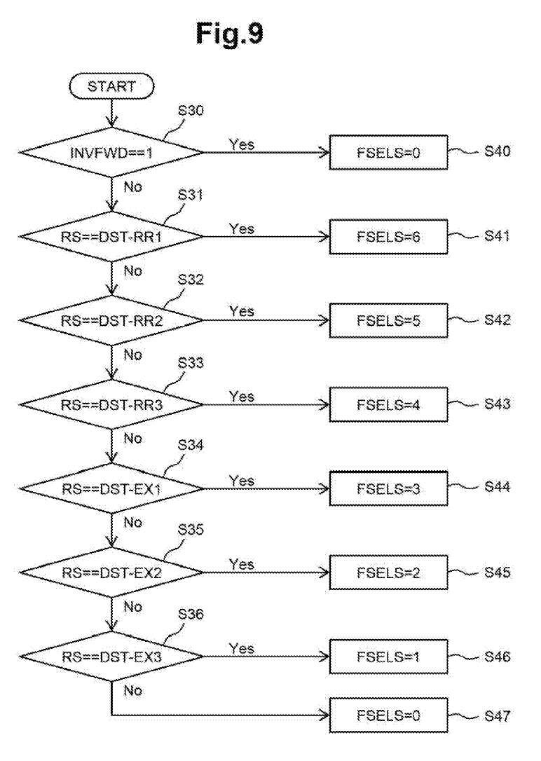

FIG. 8 is a block diagram illustrating an example of the configuration of the forwarding selectors FSEL-S1-FSEL-S3 and FSEL-T1-FSEL-T3 mounted in the VLIW processor 2. FIG. 9 is a flow chart illustrating an example of the function of the forwarding control circuits FWDCNTS1-FWDCNTS3. All of the forwarding selectors FSEL-S1-FSEL-S3, and FSEL-T1-FSEL-T3 have the same configuration, and all of the forwarding control circuits FWDCNTS1-FWDCNTS3 also have the same configuration. The forwarding control circuits FWDCNTS1-FWDCNTS3 are provided in the slots 1-3 corresponding to the source operand rs, respectively, and output the selection control signal RSELRS to the forwarding selectors FSEL-S1-FSEL-S3. The forwarding selectors FSEL-S1-FSEL-S3 are supplied with the data from the register file REGF when the forwarding is not performed and the data from the EX stage of the slots 1-3 and the data from the WB stage of the slots 1-3 as the data of the forwarding target. The forwarding selectors FSEL-S1-FSEL-S3 select one of them on the basis of the selection control signal RSELRS supplied from the forwarding control circuits FWDCNTS1-FWDCNTS3, and supply it to the rs side source input of the processing execution circuits EXEC1-EXEC3 via the pipeline registers P-RR-S1-P-RR-S3. All of the forwarding control circuits FWDCNTT1-FWDCNTT3, provided corresponding to the rt side of the processing execution circuits EXEC1-EXEC3, have the same configuration as the forwarding control circuits FWDCNTS1-FWDCNTS3 on the rs side, and output the selection control signal RSELRT to the forwarding selectors FSEL-T1-FSEL-T3. Also the forwarding selectors FSEL-T1-FSELT3 are supplied with the data from the register file REGF at the time when the forwarding is not performed, and the data from the EX stage of the slots 1-3 and the data from the WB stage of the slots 1-3, as the data of the forwarding target. On the basis of the selection control signal RSELRT supplied from the forwarding control circuits FWDCNTT1-FWDCNTT3, the Forwarding selectors FSEL-T1-FSEL-T3 select one of them and supply it to the rt side source input of the processing execution circuits EXEC1-EXEC3 via the pipeline registers P-RR-T1-P-RR-T3.

As illustrated in FIG. 9, when the forwarding invalid information INVFWD is 1 (S30), setting the selection control signal as FSELS=0 (S40), the forwarding control circuits FWDCNTS1-FWDCNTS3, control the forwarding selector FSEL-S1-FSEL-S3 to select the data read from the register file REGF and to write it in the pipeline register P-RR-S1-P-RR-S3. When the forwarding invalid information INVFWD is 0, the forwarding control circuits FWDCNTS1-FWDCNTS3 compare sequentially the source operand code RS with DST-RR1-DST-RR3 held in the pipeline registers DST-RR1-DST-RR3, respectively (S31-S33), and with DST-EX1-DST-EX3 held at the DST-EX1-DST-EX3, respectively (S34-S36). As a result, the forwarding control circuits FWDCNTS1-FWDCNTS3 output a value corresponding to a pipeline register in agreement from the selection control signal FSELS (S41-S47). That is, the source operand code RS is compared with DST-RR1 held in the pipeline register DST-RR1 (S31), and when they are in agreement, the selection control signal is set as FSELS=6 (S41). When they are in disagreement, the source operand code RS is compared with DST-RR2 held in the DST-RR2 (S32), and when they are in agreement, the selection control signal is set as FSELRS=5 (S42). When they are in disagreement, the source operand code RS is compared with DST-RR3 held in the DST-RR3 (S33), and when they are in agreement, the selection control signal is set as FSELRS=4 (S43). When they are in disagreement, the source operand code RS is compared with DST-EX1 held in the pipeline register DST-EX1 (S34), and when they are in agreement, the selection control signal is set as FSELS=3 (S44). When they are in disagreement, the source operand code RS is compared with DST-EX2 held in the DST-EX2 (S35), and when they are in agreement, the selection control signal is set as FSELRS=2 (S45). When they are in disagreement, the source operand code RS is compared with DST-EX3 held in the DST-EX3 (S36), and when they are in agreement, the selection control signal is set as FSELRS=1 (S46). Furthermore, when they are in disagreement, the selection control signal is set as FSELS=0 (S47). It should be noted that the meaning of the numerical value assigned to the forwarding invalid information INVFWD or the selection control signal FSELS is arbitrary, and what is illustrated here is only an example. Although not shown in the figure, the function of the forwarding control circuits FWDCNTT1-FWDCNTT3 provided corresponding to the rt side of the processing execution circuits EXEC1-EXEC3 is the same as the function of the forwarding control circuits FWDCNTS1-FWDCNTS3 provided on the rs side, and outputs the selection control signal RSELRT to the forwarding selectors FSEL-T1-FSEL-T3.

The above explanation is made for the case where the three-slot processing execution circuits EXEC1-EXEC3 have the same function and are provided with two sources and one destination, respectively, as illustrated in FIG. 5. However, as described above, the number of slots is arbitrary and the function implemented in each slot is also arbitrary. Depending on the number of the sources included in the processing execution circuit EXEC implemented in each slot, the processor control circuit CTRL includes the forwarding control circuit of the same number, and controls the forwarding selector FSEL of the same number coupled to the processing execution circuit EXEC. It is preferable that a processing execution circuit EXEC capable of executing only a register store instruction and not provided with a source may be implemented in a part of slots. For example, a load instruction (load immediate instruction) in which the address to be accessed is specified by an immediate value and a move instruction (move immediate instruction) in which the value to be written is specified by an immediate value do not have a source operand. In the slot implemented with the processing execution circuit EXEC having only such a function, any forwarding selector FSEL is not implemented, and the processor control circuit CTRL does not include a forwarding control circuit corresponding to the slot. Such a processing execution circuit EXEC without a source can function also as a forwarding source. The example of the configuration which allows the forwarding from other arbitrary slots is illustrated in FIG. 5-FIG. 9. However, it is also preferable to change the configuration so that only the forwarding from the limited range may be allowed on the basis of restrictions of the circuit scale or wiring density, in consideration of the feature of the software to be executed.

<A Software Pipeline>

The VLIW processor is suitable for software pipelining. FIG. 5 illustrates the three-slot VLIW processor due to restriction of space, and the embodiment described in the following illustrates a simple example for the sake of clarity. However, the number of slots to be implemented in the VLIW processor is arbitrary, and the larger number of slots can make the more efficient software pipelining of the repeat loop which includes many instruction steps.

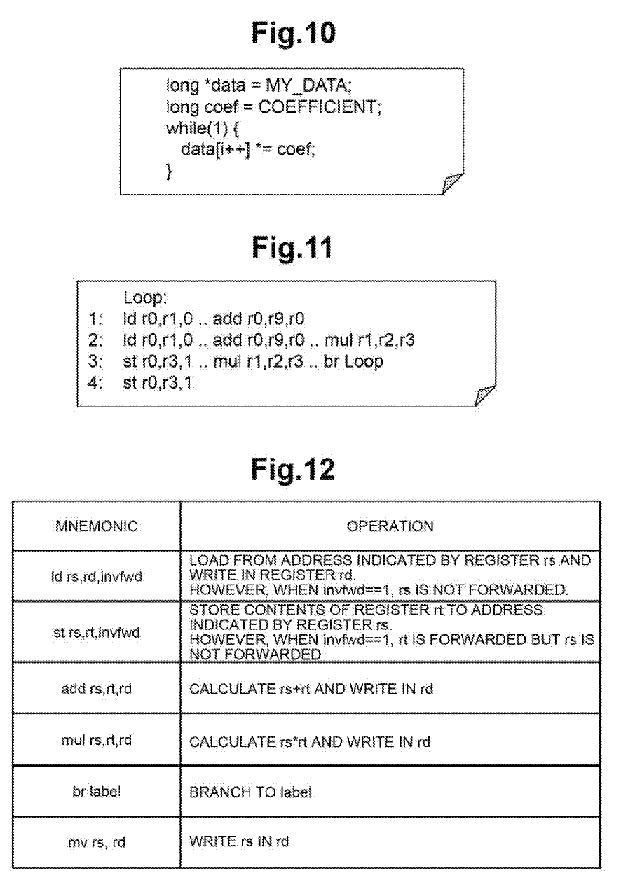

FIG. 10 is an explanatory drawing illustrating an example of a program described in a high level language, to be executed by the VLIW processor illustrated in FIG. 5. A value of a long word array variable MY_DATA is written in an address indicated by pointer data, a value of a long word coefficient COEFFICIENT is written in a long word variable coef and a repeat (while) loop is started. In the loop, the processing in which data data[i]* is read from the address indicated by the index i and is multiplied by the coefficient coef and then stored in the same address, and the processing in which the index i is incremented by 1 is executed. Here, the symbol * designates a pointer. This processing is what is called a read-modify-write, and is used frequently in array operation.

FIG. 11 is an explanatory drawing illustrating an example of a program described in assembly language, to be executed by the processor illustrated in FIG. 5. FIG. 12 is an explanatory drawing illustrating operation of an instruction described in assembly language used by the program illustrated in FIG. 11. A load instruction ld has a source operand rs, a destination operand rd, and forwarding invalid information invfwd as the operands, and loads data from the address indicated by the register rs, and writes it in the register rd. However, when invfwd==1, rs does not perform the forwarding. A store instruction st has two source operands rs and rt and the forwarding invalid information invfwd as the operands, and stores the contents of the register rt into the address indicated by the register rs. However, when of invfwd==1, rt is forwarded but rs is not forwarded. An add instruction add has two source operands rs and rt and a destination operand rd as the operands, and calculates rs+rt and writes the calculation result into rd. A multiply instruction mul has two source operands rs and rt and a destination operand rd as the operands, and calculates rs*rt and writes the calculation result into rd. Here, the symbol designates multiplication. A branch instruction br has label as the operand, and branches unconditionally to label. A move instruction my has a source operand rs and a destination operand rd as the operands, and writes the data of the register rs in the register rd.

FIG. 11 illustrates an example of a program described in an assembly language. The figure illustrates a portion of the converted (compiled) repeat loop of the program illustrated in FIG. 10.

At Step 1, the load instruction (ld) and the add instruction (add) are mapped. That is, the load instruction (ld) and the add instruction (add) are issued in parallel by one word VLIW, and they are executed in parallel in different slots. By the load instruction (ld), data data[i] is read from the address specified by a register r0 to which the index i is mapped, into the register r1. By the add instruction (add), a value 1 of a register r9 which has been initialized to 1 by an initialization routine (not shown) is added to a value of the register r0 in which the index i is stored, and it is restored to the register r0. It is an increment i++ of the index i.

At Step 2, the load instruction (ld), the add instruction (add), and the multiply instruction (mul) are mapped. That is, the load instruction (ld), the add instruction (add), and the multiply instruction (mul) are issued in parallel by one word VLIW, and they are executed in parallel in different slots. By the load instruction (ld), data data[i] is read from the address specified by the register r0 to which the index i is mapped, into the register r1. By the add instruction (add), a value (1) of the register r9 is added to a value of the register r0 in which the index i is stored, and restored to the register r0. The index i at this time is a value already incremented by the add instruction (add) at Step 1, and the value restored to the register r0 is a value further incremented. By the multiply instruction (mul), a value of the register r1 in which the data data[i] has been loaded at Step 1 and a value of the register r2 initialized to a coefficient value COEFFICIENT by the initialization routine (not shown) are multiplied, and the result is written in a register r3.

At Step 3, the store instruction (st), the multiply instruction (mul), and the branch instruction (br) are mapped. That is, the store instruction (st), a multiply instruction (mul), and the branch instruction (br) are issued in parallel by one word VLIW, and they are executed in parallel in different slots. The data stored in register r3 as the result that the data data[i] has been loaded at Step 1 and the data data[i] and COEFFICIENT have been multiplied at Step 2 is stored in the address specified by the register r0 by the store instruction (st). Here, the forwarding invalid information appended to the store instruction (st) is set as INVFWD=1 and the forwarding is not performed. The value of the register r0 to which the store instruction (st) refers is twice incremented by the add instruction (add) at Step 1 and Step 2. However, both of the results do not arrive at a write back (WB) stage, and they are not written in the register file REGF. Therefore, when the store instruction (st) refers to the register r0 of the register file REGF at Step 3, the value which the load instruction (ld) has referred to at Step 1 is referred to as it is. As a result, the product of the data data[i] and COEFFICIENT is restored to the same address as the address where the data data[i] have been stored.

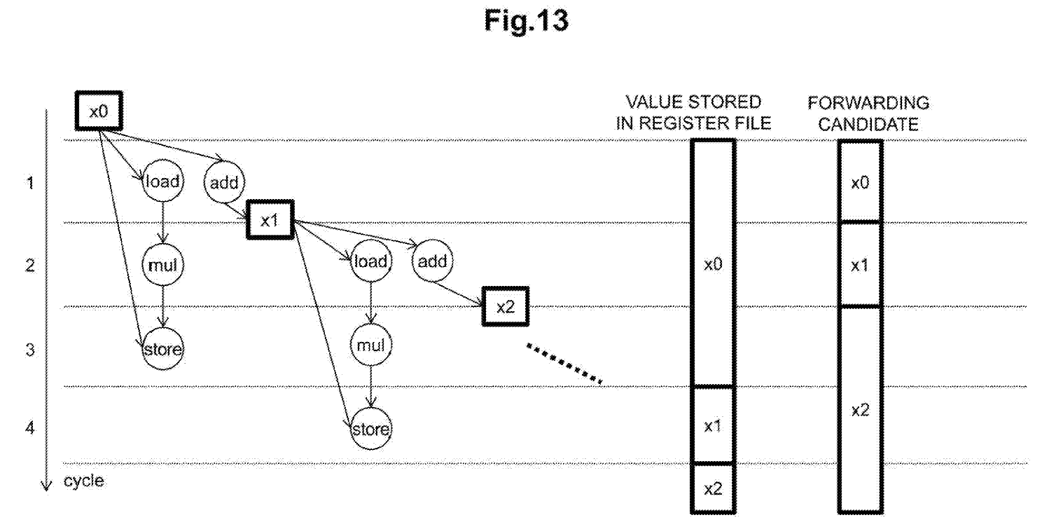

FIG. 13 is a timing chart illustrating schematically the above-described operation of the VLIW processor 2. In the vertical direction, the number of cycles is shown, each instruction is shown with the dependency relation, that is, the reference relation of a variable, and in addition, the value of the register r0 stored in the register file REGF and a forwarding candidate as the value of the register r0 are shown. Cycle 1 is the beginning of the repeat loop and corresponds to Step 1 described above at which the load instruction (ld) and the add instruction (add) are executed. Both the load instruction (ld) and the add instruction (add) refer to x0 as the value of the register r0. The result of the load instruction (ld) is referred to by the multiply instruction (mul) in the following Cycle 2, and the result of the multiply instruction (mul) is referred to by the store instruction (st) in the following Cycle 3. The store instruction (st) at Cycle 3 refers to the same register r0 as the load instruction (ld) at Cycle 1 refers to, and stores the multiplication result into the address specified by the same value x0. At Cycle 1, the add instruction (add) increments x0 referred to as the value of the register r0, and outputs x1. x1 as the addition result at this time is a register read (RR) stage. Therefore, it is at Cycle 4 of the write back (WB) stage that the addition result x1 is written in the register r0 of the register file REGF. Therefore, in the cycles till then, the addition result x1 is held as a forwarding candidate at a pipeline register P-EX, for example. The load instruction (ld) and the add instruction (add) at Cycle 2 are the second time of the repeat loop, and it is necessary to refer to the incremented index i. Accordingly, the addition result x1 by the forwarding is referred to. The add instruction (add) at Cycle 2 outputs an addition result x2 further, and the result is also held as a forwarding candidate at the pipeline register P-EX, for example. As described above, the following repeat loop can be started before the value of the register r0 holding the index i is updated in the write back (WB) stage, thereby enabling the software pipelining. The initiation interval in the present example is one cycle. At this time, the forwarding is made invalid to the store instruction (st), and a value held in the register file REGF as the result of the increment without being reflected is referred to. Therefore, the read-modify-write processing is executed properly. In this way, it is possible to specify whether to prohibit or to permit the forwarding (forwarding OFF/ON) for every instruction.

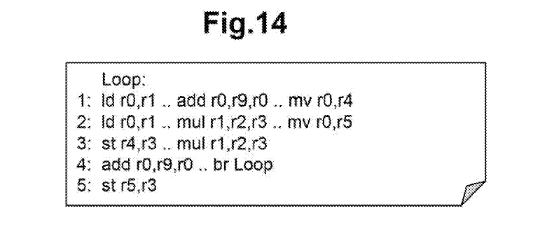

FIG. 14 is an explanatory drawing illustrating an example of not performing the ON/OFF specification of the forwarding. As compared with the assembly program illustrated in FIG. 11, the present program is comprised of five steps which are larger by one step. The move instruction (mv) is added to Step 1 and Step 2, the add instruction (add) at Step 2 and the brunch instruction (br) at Step 3 are moved to Step 4, and the store instruction (st) at Step 4 is moved to Step 5. While r0 holding the index i is incremented by the add instruction (add) at Step 1, the store instruction (st) at Step 3 needs to refer to the same value of the index i, that is, the value before the increment. Accordingly, r0 is copied to the register r4 by the move instruction (mv) at Step 1, and the store instruction (st) at Step 3 refers to this register r4. Similarly, in the second repeat loop, the value of r0 holding the incremented index i is referred to by the load instruction (ld) at Step 2 and is further incremented at Step 4, however, the store instruction (st) at Step 5 needs to refer to the same value of the index i, that is, the value before the increment. Accordingly, the value of r0 holding the index i referred to by the load instruction (ld) is copied to the register r5 by the move instruction (mv) at Step 2, and the store instruction (st) at Step 5 refers to this register r5.

As described above, in the program illustrated in FIG. 14 which does not perform the ON/OFF specification of the forwarding, the number of registers to be used is seven of r0-r5, and r9, and the number of steps to configure the repeat loop is four. As opposed to this, in the program illustrated in FIG. 11 which performs the ON/OFF specification of the forwarding, the number of registers to be used is five of r0-r3, and r9, which is fewer by two pieces and the number of steps composing the repeat loop is three, which are smaller by one step. In this way, it is possible to specify whether to prohibit or to permit the forwarding (forwarding OFF/ON) for every instruction. Therefore, it is possible to make improvements in the performance by the software pipelining, without increasing the number of registers to be implemented in the register file.

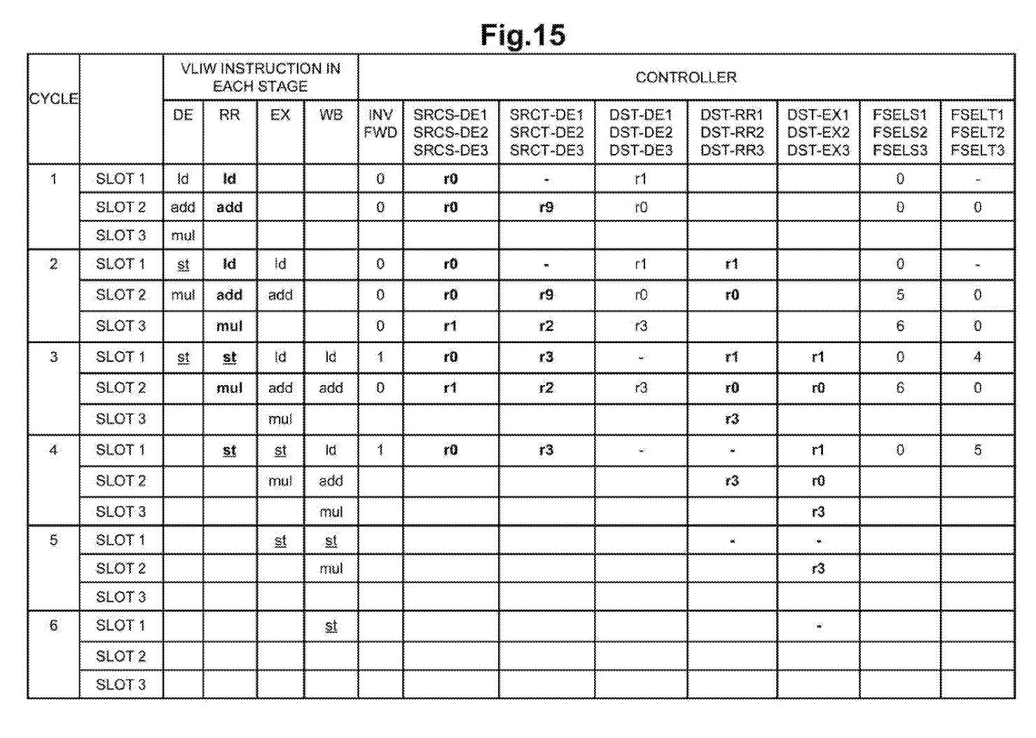

FIG. 15 is an explanatory drawing illustrating more detailed operation of the VLIW processor 2 explained with reference to FIG. 11 and FIG. 13. In the figure, an execution cycle and the state of slots 1-3 in each cycle are shown in the vertical direction, and a VLIW instruction of each pipeline stage and a value of each pipeline register of the processor controller CTRL are shown in the horizontal direction. Although the number of pipeline stages of the VLIW processor 2 is arbitrary, the figure illustrates an example in which the VLIW processor 2 is comprised of a four-step pipeline of a decode (DE) stage, a register read (RR) stage, an execution (EX) stage, and a write back (WB) stage.

At Cycle 1, the load instruction (ld) and the add instruction (add) at Step 1 of FIG. 11 are sent to the register read (RR) stage of the slot 1 and the slot 2, respectively, and the load instruction (ld), the add instruction (add), and the multiply instruction (mul) at Step 2 of FIG. 11 are sent to the decode (DE) stage of the slot 1, the slot 2, and the slot 3, respectively. r0 as the source operand (rs) of the load instruction (ld) of the slot 1 is held in SRCS-DE1, and r1 as the destination operand is held in DST-DE1, respectively. At this time, the forwarding invalid information INVFWD is INVFWD=0 and the forwarding is permitted (ON). However, there is no appropriate forwarding source for DST-RR1-DST-RR3 and DST-EX1-DST-EX3, accordingly, the selection control signal FSELS1 of the forwarding selector FSEL-S1 is FSELS1=0. r0 and r9 as the source operands rs and rt of the add instruction (add) of the slot 2 are held in SRCS-DE2 and SRCT-DE2, and r0 as the destination operand is held in DST-DE2, respectively. Also at this time, the forwarding invalid information INVFWD is INVFWD=0 and the forwarding is permitted (ON). However, there is no appropriate forwarding source for DST-RR1-DST-RR3 and DST-EX1-DST-EX3, accordingly, the selection control signal FSELS2 of the forwarding selector FSEL-S2 is FSELS2=0.

At Cycle 2, the load instruction (ld), the add instruction (add), and the multiply instruction (mul) at Step 2 are sent to the register read (RR) stage of the slot 1, the slot 2, and the slot 3, respectively. r0 as the source operand (rs) of the load instruction (ld) of the slot 1 is held in SRCS-DE1, and r1 as the destination operand is held in DST-DE1, respectively. At this time, the forwarding invalid information INVFWD is INVFWD=0 and the forwarding is permitted (ON). However, there is no appropriate forwarding source for DST-RR1-DST-RR3 and DST-EX1-DST-EX3, accordingly, the selection control signal FSELS1 of the forwarding selector FSEL-S1 is FSELS1=0. r0 and r9 as the source operands rs and rt of the add instruction (add) of the slot 2 are held in SRCS-DE2 and SRCT-DE2, and r0 as the destination operand is held in DST-DE2, respectively. At this time, the forwarding invalid information INVFWD is INVFWD=0 and the forwarding is permitted (ON), and DST-RR2=r0 is in agreement with SRCS-DE2=r0, and is selected as a forwarding source, accordingly, the selection control signal FSELS2 of the forwarding selector FSEL-S2 becomes FSELS2=5. That is, in the state where the output from the add instruction (add) of the slot 2 at Cycle 1 is still in the register read (RR) stage, the forwarding is performed to the source operand (rs) of the add instruction (add) of the slot 2 at Cycle 2. r1 and r2, as the source operands rs and rt of the multiply instruction (mul) of the slot 3, are held in SRCS-DE3 and SRCT-DE3, and r3 as the destination operand is held in DST-DE3, respectively. At this time, the forwarding invalid information INVFWD is INVFWD=0 and the forwarding is permitted (ON). DST-RR1=r1 is in agreement with SRCS-DE3=r1, and is selected as a forwarding source, accordingly, the selection control signal FSELS3 of the forwarding selector FSEL-S3 becomes FSELS3=6. That is, in the state where the output from the store instruction (st) of the slot 2 at Cycle 1 is still in the register read (RR) stage, the forwarding is performed to the source operand (rs) of the multiply instruction (mul) of the slot 3 at Cycle 2.

At Cycle 3, the store instruction (st) and the multiply instruction (mul) at Step 3 are sent to the register read (RR) stage of the slot 1 and the slot 2, respectively. r0 and r3 as the source operands rs and rt of the store instruction (st) of the slot 1 are held in SRCS-DE1 and SRCT-DE1, respectively. At this time, the forwarding invalid information INVFWD is INVFWD=1 and the forwarding is prohibited (OFF). Therefore, the forwarding is prohibited (OFF) as for the source operand rs, however, the forwarding is permitted (ON) as for the source operand rt. Therefore, the selection control signal FSELS1 of the forwarding selector FSEL-S1 becomes FSELS1=0. On the other hand, as for the source operand rt side to which the forwarding is permitted (ON), DST-RR3=r3 is in agreement with SRCT-DE1=r3. Therefore, the selection control signal FSELT1 of the forwarding selector FSEL-T1 becomes FSELT1=4. That is, in the state where the output from the multiply instruction (mul) of the slot 3 at Cycle 2 is still in the register read (RR) stage, the forwarding is performed to the source operand (rt) of the store instruction (st) of the slot 1 at Cycle 3. r1 and r2, as the source operands rs and rt of the multiply instruction (mul) of the slot 2, are held in SRCS-DE2 and SRCT-DE2, and r3 as the destination operand is held in DST-DE2, respectively. At this time, the forwarding invalid information INVFWD is INVFWD=0 and the forwarding is permitted (ON). Both DST-RR1=r1 and DST-EX1=r1 are in agreement with SRCS-DE3=r1. Therefore, most recently updated DST-RR1=r1 is selected as the forwarding source, and the selection control signal FSELS2 of the forwarding selector FSEL-S2 becomes FSELS2=6. That is, in the state where the output from the store instruction (st) of the slot 2 at Cycle 2 is still in the register read (RR) stage, the forwarding is performed to the source operand (rs) of the multiply instruction (mul) of the slot 2 at Cycle 3.

At Cycle 4, the store instruction (st) at Step 4 is sent to the register read (RR) stage of the slot 1. r0 and r3, as the source operands rs and rt of the store instruction (st) of the slot 1, are held in SRCS-DE1 and SRCT-DE1, respectively. At this time, the forwarding invalid information INVFWD is INVFWD=1 and the forwarding is prohibited (OFF). Therefore, the forwarding is prohibited (OFF) as for the source operand rs, however, the forwarding is permitted (ON) as for the source operand rt. Accordingly, the selection control signal FSELS1 of the forwarding selector FSEL-S1 becomes FSELS1=0. On the other hand, as for the source operand rt side to which the forwarding is permitted (ON), DST-RR2=r3 is in agreement with SRCT-DE1=r3. Therefore, the selection control signal FSELT1 of the forwarding selector FSEL-T1 becomes FSELT1=5. That is, in the state where the output from the multiply instruction (mul) of the slot 2 at Cycle 3 is still in the register read (RR) stage, the forwarding is performed to the source operand (rt) of the store instruction (st) of the slot 1 at Cycle 4.

As understood from the detailed example of the operation described above, the forwarding actually arises when the processing result of a certain instruction remains in a previous stage than arriving at the write back (WB) stage. Therefore, the effect is produced by arranging the instruction to specify ON/OFF of the forwarding at a previous step than the write back to a register of the forwarding source is executed. Accordingly, the larger the number of pipeline stages in the processor is, the greater improvement in performance by the software pipelining is obtained.

### Embodiment 2

### A Processor Capable of Specifying the Forwarding Source

Embodiment 1 explains the processor which can specify whether to prohibit or to permit the forwarding for every instruction. However, it is preferable to employ a configuration in which it is possible to permit the forwarding with the forwarding source specified, in addition to the simple permission which does not specify a forwarding source when permitting. That is, it is preferable to employ a configuration in which the instruction set executed by the processor includes the instruction provided with a field (fsrc) to specify whether to prohibit the forwarding or to permit the forwarding from which stage of the pipeline in an instruction code, in place of or in addition to the instruction provided with a field (f) to specify whether to prohibit or to permit forwarding in an instruction code. According to this configuration, it is possible not only to simply specify whether to prohibit or to permit the forwarding, but it is possible to specify which pipeline stage to serve as a forwarding source, when permitting. Accordingly, it is possible to enhance the degree of freedom. In the following, the detailed explanation thereof is made.

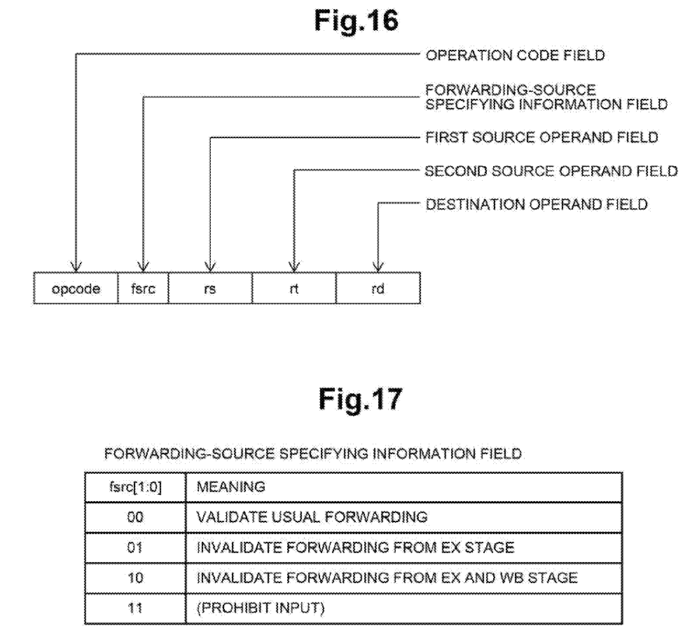

FIG. 16 is an explanatory drawing illustrating an example of the configuration of an instruction code to be executed by a processor according to Embodiment 2. The instruction code includes an operation code field opcode, a forwarding-source specifying information field fsrc, a first source operand field rs, a second source operand field rt, and a destination operand field rd. The difference from the example of the configuration of the instruction code executed by the processor according to Embodiment 1 illustrated in FIG. 2 is the point that the forwarding-source specifying information field fsrc is included in place of the forwarding invalid information field f. The explanation about other operation codes and the field of operands is the same as the explanation made in Embodiment 1 with reference to FIG. 2. Therefore, the explanation thereof is omitted.

FIG. 17 is an explanatory drawing about a forwarding-source specifying information field in the instruction code illustrated in FIG. 16. The forwarding-source specifying information field fsrc is comprised of 2 bits, where 00 is specification to validate the ordinary forwarding, 01 is specification to invalidate forwarding from the execution (EX) stage, 10 is specification to invalidate forwarding from the execution (EX) stage and the write back (WB) stage, and 11 is specification to prohibit an input. The specification to validate the ordinary forwarding by fsrc=00 is equivalent to the specification to permit the forwarding (forwarding ON) by f=0 (INVFWD=0) in FIG. 2. The specification to invalidate forwarding from the execution (EX) stage and the write back (WB) stage by fsrc=10 is equivalent to the specification to prohibit forwarding (forwarding OFF) by f=1 (INVFWD=1) in FIG. 2. When there are more number of pipeline stages in the processor, it is possible to increase the forwarding-source specifying information field fsrc. According to this configuration, it is possible to specify more finely the validity/invalidity of the forwarding from each pipeline stage.

It is possible to include in the instruction set an instruction with a forwarding invalid information field f of bit as illustrated in FIG. 2, an instruction with a forwarding-source specifying information field fsrc of 2 bits as illustrated in FIG. 17 or of 3 or more bits, or an instruction with neither, respectively in arbitrary numbers.

The configuration of the processor which can execute the instruction included in such an instruction set is the same as that of the processor 1 illustrated in FIG. 1, or the VLIW processor 2 illustrated in FIG. 5. At this time, the configuration of the forwarding selectors FSEL, FSEL-S1-FSEL-S3, FSEL-T1-FSEL-T3 is the same as the configuration illustrated in FIG. 3 and FIG. 8. The configuration of the processor control circuit CTRL is the same as the configuration illustrated in FIG. 1 and FIG. 7 except that the pipeline registers FWD-DE and FW-DE1-FW-DE3 are replaced with the pipeline register holding the forwarding-source specifying information field fsrc. The function of the forwarding control circuits FWDCNT, FWDCNTS1-FWDCNTS3, FWDCNTT1-FWDCNTT3 are changed so as to properly generate the selection control signals FSELS, FSELS1-FSELS3, FSELT, FSELT1-FSELT3, to control the forwarding selectors FSEL, FSEL-S1-FSEL-S3, FSEL-T1-FSEL-T3, on the basis of the forwarding-source specifying information field fsrc.

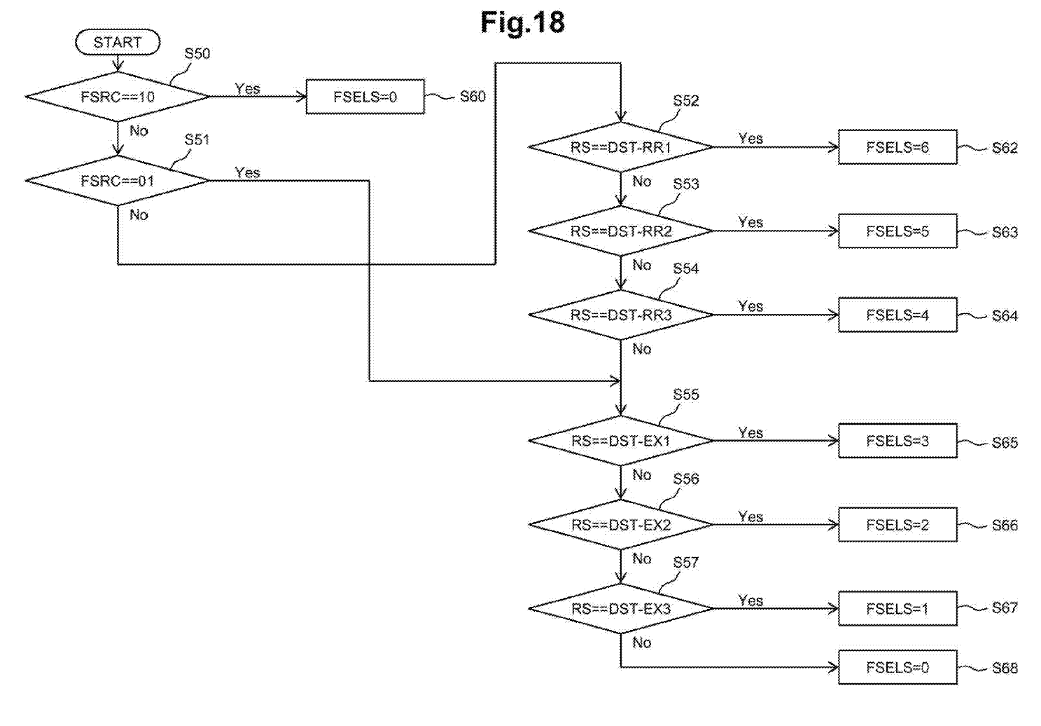

FIG. 18 is a flow chart illustrating an example of the function of the forwarding control circuits FWDCNTS1-FWDCNTS3 mounted in the processor according to Embodiment 2. Same applies to the forwarding control circuits FWDCNTT1-FWDCNTT3. When the forwarding-source specifying information fsrc is fsrc-10 (S50), that is, when the forwarding from the execution (EX) stage and the write back (WB) stage is rendered invalid, the forwarding control circuits FWDCNTS1-FWDCNTS3 set the selection control signal FSELS as FSELS=0 (S60). According to this configuration, the forwarding selectors FSEL-S1-FSEL-S3 are controlled to select the data read from the register file REGF and to write it in the pipeline registers P-RR-S1-P-RR-S3, and the forwarding is not performed. When the forwarding-source specifying information fsrc is fsrc==01 (S51), that is, when the forwarding from the execution (EX) stage is rendered invalid, it only necessary to determine the validity/invalidity of the forwarding from the write back (WB) stage. Therefore, the flow branches to Step S55 to be described later. When the forwarding-source specifying information fsrc is not 10 nor 01, the forwarding control similar to one illustrated in FIG. 9 is executed. The source operand code RS is compared sequentially with DST-RR1-DST-RR3 held in the pipeline registers DST-RR1-DST-RR3, respectively (S52-S54), and with DST-EX1-DST-EX3 held in DST-EX1-DST-EX3, respectively (S55-S57), and the value corresponding to a pipeline register in agreement is outputted from the selection control signal FSELS (S62-S67). When neither is in agreement, FSELS=0 is outputted (S68). This function is the same as the function of steps S31-S36 and S41-S47 illustrated in FIG. 9. Therefore, the explanation thereof is omitted.

As described above, it is possible not only to simply specify whether to prohibit or to permit the forwarding, it is also possible to specify which pipeline stage to be assigned as a forwarding source, when permitting; accordingly it is possible to enhance the degree of freedom. When the processor which can execute such an instruction is implemented with the VLIW processor, it is possible to make improvements in the performance by the software pipelining, without increasing the number of registers to be implemented in the register file. In the VLIW processor, it is possible to intermingle, in the instructions issued in parallel, the instruction which can simply specify whether to prohibit or to permit the forwarding as illustrated in FIG. 2, and the instruction which can specify which pipeline stage to be assigned as a forwarding source when permitting as illustrated in FIG. 16. It is possible to assign an arbitrary slot as the slot in which those instructions are arranged, or to fix the slot to a part of slots. The degree of freedom becomes high by the former, and the circuit scale is reduced by the latter. As is the case with the explanation in Embodiment 1, it is possible to employ a configuration which allows the forwarding from other arbitrary slots, or a configuration which allows the forwarding only from a part of the slots. The degree of freedom becomes high by the former, and the circuit scale is reduced by the latter.

### Embodiment 3

### A Program Code Translator (Optimizer)

Forwarding exerts its functions when the result of an instruction executed earlier is written in a destination register specified by the instruction and when another instruction which refers to the destination register is executed in an earlier stage than the pipeline stage of the destination register. Here, the earlier instruction is called a register store instruction and the subsequent instruction is called a register reference instruction. Embodiments 1 and 2 demonstrate that it is possible to attain the improvement in performance by the software pipelining, by considering the register reference instruction as the instruction which can specify only whether to prohibit or to permit the forwarding, or the instruction which can specify which pipeline stage to serve as a forwarding source when permitting. Embodiment 3 explains a program code translator (optimizer) for using this technology more positively. The program code translator (optimizer) is incorporated as a partial function of a program development device which is comprised of a compiler, an assembler, and a linker.

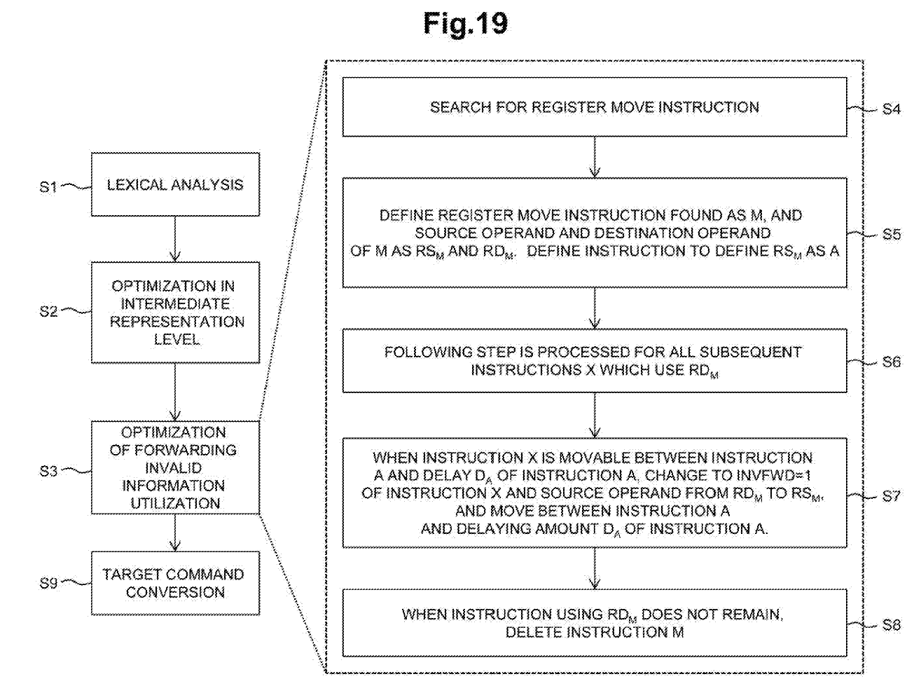

FIG. 19 is a flow chart illustrating an example of the function of a program development device according to Embodiment 3. The function of the program development device includes Steps from S1 to S9. At Step 1 (S1), to an inputted program described in a high level language, the lexical analysis of the description is conducted to convert the inputted program into an intermediate representation level program. At Step 2 (S2), prescribed optimization is performed to the intermediate representation level program. For example, when the target processor is a VLIW, at Step 2 (S2), the optimization is executed in which the program code included in the intermediate representation level program is assigned to the appropriate slot of the multiple slots composing the VLIW, to minimize the number of execution steps. These functions are the same as the function implemented in a well-known compiler. The ordinary program development device advances to a target instruction conversion step (S9) next to Step 2 (S2) and converts the optimized program code of the intermediate representation level into an instruction code in a machine language.

In the program development device according to Embodiment 3, Step 3 (S3) is added to perform optimization utilizing the forwarding invalid information. Step 3 (S3) is comprised of Step 4 (S4)-Step 8 (S8), for example.

At Step 4 (S4), a register move instruction is searched first. Here, the register move instruction is an instruction to write a value stored in a register specified by a source operand into a register specified by a destination operand. In the assembly language, it is usually expressed by a move instruction (mv).

Next, at Step 5 (S5), the register move instruction extracted at S4 is set to M, the source operand and the destination operand are set to RS_{M} and RD_{M}, respectively, and an instruction which defines RS_{M} is searched and is set to A. The instruction A is a register store instruction to be executed at a later step than the instruction M or at the same step as M.

Next, at Step 6 (S6), as for all the subsequent instructions X that use RD_{M}, the following Step 7 (S7) is processed. The instruction X is a register reference instruction to be executed at a later step than the instruction M.

At Step 7 (S7), it is determined whether it is possible to move the instruction X to a step between the instruction A and a delay D_{A} of A. Here, the instruction A is a register store instruction which defines RS_{M}, and the delay D_{A} indicates a period (the number of steps) from the step at which the instruction A is present until RS_{M} is rewritten by the execution result of the instruction A. When it is possible to move the instruction X to a step between the instruction A and the delay D_{A} of A, the forwarding invalid information INVFWD of the instruction X is set as INVFWD=1 (forwarding OFF), the source operand is changed from RD_{M} to RS_{M}, and the instruction X is moved to a step between the instruction A and the delay D_{A}. Same applies when the instruction X is arranged from the beginning at a step between the instruction A and the delay D_{A} of A.

After processing Step 7 (S7) for all the instructions X extracted at Step 6 (S6), at Step 8 (S8), the instruction M is deleted when no instruction which uses RD_{M} remains.

According to this configuration, in the program to be executed by the processor explained in Embodiments 1 and 2, it is possible to attain the optimization for aiming at improvement in performance by the software pipelining. That is, the forwarding ON/OFF specification for the software pipelining can be determined by analyzing a program, and the appropriate forwarding invalid information can be supplied automatically.

The program code translator (optimizer) is incorporated as a partial function of the program development device composing a compiler, an assembler, and a linker. In addition to this, the program code translator (optimizer) may be provided as software to be added to the existing program development device.

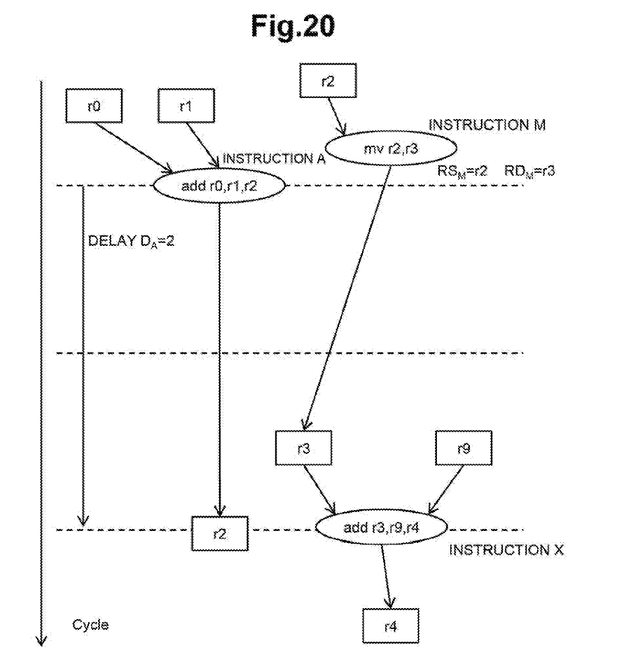

FIG. 20 is a schematic timing chart illustrating operation by a program before translation by a program code translator (optimizer). FIG. 20 corresponds to the program of the intermediate representation level after the optimization at Step 2 (S2) in the flow chart illustrated in FIG. 19 is made, that is before the optimization utilizing the forwarding invalid information is made. The execution cycle of a processor is shown in the vertical direction. In the figure, an instruction to be executed is shown by an ellipse, and a register to which reference is made or in which an execution result is stored is shown by a rectangle. The dashed lines show the interval of 1 cycle. An instruction “add r0, r1, r2” (instruction A) is an add instruction which refers to the source registers r0 and r1 and adds them, and stores the addition result in the destination register r2. The ellipse surrounding the instruction “add r0, r1, r2” (instruction A) expresses a register read (RR) cycle, and it is illustrated schematically that the write to the destination register r2 is performed in the write back stage at 2 cycles later. The number of cycles from the instruction A to the write back to the destination register is defined as the delay D_{A}. In this example, the delay D_{A} is D_{A}=2. An instruction “mv r2, r3” (instruction M) is a move instruction (mv) which copies the register r2 to which the instruction A is going to rewrite the contents, to another register r3. The instruction “mv r2, r3” (instruction M) is arranged at the previous cycle than the instruction “add r0, r1, r2” (instruction A) or at the same cycle, and evacuates the value of the register r2 before being rewritten by the instruction A to the register r3. An instruction “add r3, r9, r4” (instruction X) in the latter stage is an add instruction which refers to the evacuated register r3.

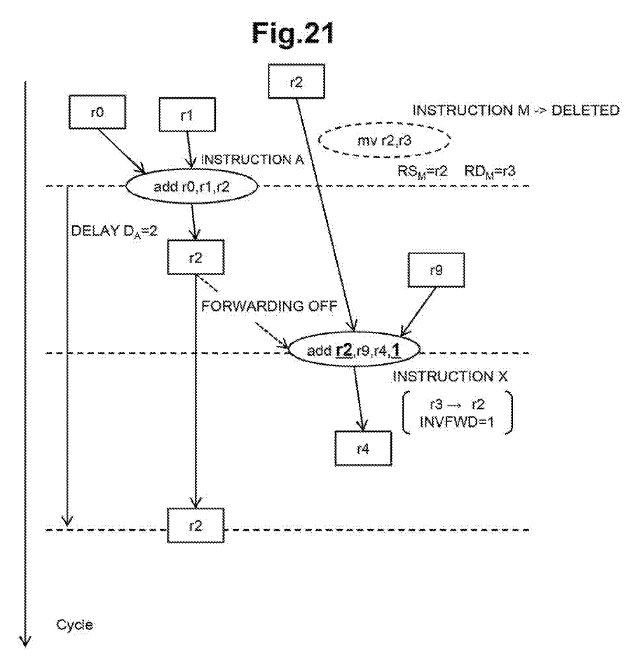

FIG. 21 is a schematic timing chart illustrating operation by a program after translation by the program code translator (optimizer). The program code translator (optimizer) searches the register move instruction M (S4) in the program of the intermediate representation level illustrated in FIG. 20 according to the flow chart illustrated in FIG. 19. The move instruction “mv r2, r3” illustrated in FIG. 20 is extracted as the instruction M. At this time, the source register RS_{M} is RS_{M}=r2 and the destination register RD_{M} is RD_{M}=r3. Next, the instruction A which defines the source register RS_{M} is RS_{M}=r2 is searched. The add instruction “add r0, r1, r2” corresponds to this. At Step 6 (S6), all the subsequent instructions X which use RD_{M}=r3 are searched. In FIG. 20 and FIG. 21, the add instruction “add r3, r9, r4” corresponds to this. At Step 7 (S7), the operation to move the instruction X is performed. That is, the add instruction “add r3, r9, r4” (instruction X) is moved to a cycle within the delay D_{A} of the instruction A, that is, to a cycle which is behind the instruction A by one cycle, as illustrated in FIG. 21. In connection with this, the forwarding is set to OFF (prohibited) by setting the forwarding invalid information INVFWD of this instruction X as INVFWD=1, and the source operand of the instruction X is changed from RD_{M}=r3 to RS_{M}=r2. According to this configuration, since the forwarding is set to OFF (prohibited), the instruction X (add r2, r9, r4, 1) does not refer to r2 as the execution result of the immediately preceding instruction A (add r0, r1, r2) by the forwarding, but can refer to the contents of r2 before it is rewritten by the instruction A (add r0, r1, r2). Although not illustrated in FIG. 21, when the movement at Step 7 (S7) is performed for all of the similar instruction X, the instruction which refers to r3 does not remain. Therefore, the register move instruction M (mv r2, r3) which has become unnecessary is deleted (S8).

The comparison of FIG. 20 and FIG. 21 clarifies the following point. By arranging the instruction X at a cycle to which the forwarding from the instruction A is possible, the number of whole cycles can be effectively reduced and the register move instruction M can be deleted; accordingly, it is possible to reduce the number of instructions actually executed and the number of registers used.

As described above, the invention accomplished by the present inventors has been concretely explained based on the embodiments. However, it is needless to say that the present invention is not restricted to the embodiments as described above, and it can be changed variously in the range which does not deviate from the gist.

For example, the processor 1 and the VLIW processor 2 may be implemented as a high-performance processor which is coupled with a cache memory, a common bus, a nonvolatile memory coupled to the common bus, an RAM, an interrupt control circuit, a direct memory controller, and a peripheral module. Furthermore, the processor 1 and the VLIW processor 2 may be implemented as a multiple-processor configured with a multiple of the processor 1 and the VLIW processor 2.

What is claimed is:

1. A processor operable to be specified whether to permit or to prohibit forwarding in an instruction, operable to refer to a register file when executing an instruction of which the forwarding is prohibited, and operable to refer to an intermediate stage of a pipeline which writes data in the register file when executing an instruction of which the forwarding is permitted.

2. The processor according to claim 1,
wherein an instruction set executable by the processor includes an instruction of which an instruction code is provided with a field to specify whether to permit or to prohibit the forwarding.

3. The processor according to claim 2,
wherein an instruction word comprised of an instruction code of a plurality of instructions included in the instruction set is issued in parallel, the instructions are executed in parallel, and the instruction word includes one or more instructions of which each instruction code is provided with a field to specify whether to permit or to prohibit the forwarding.

4. The processor according to claim 1,
wherein an instruction set executable by the processor includes an instruction of which an instruction code is provided with a field to specify whether to prohibit the forwarding or to permit the forwarding from which stage of the pipeline.

5. The processor according to claim 4,
wherein an instruction word comprised of an instruction code of a plurality of instructions included in the instruction set is issued in parallel, the instructions are executed in parallel, and the instruction word includes one or more instructions of which each instruction code is provided with a field to specifies whether to prohibit the forwarding or to permit the forwarding from which stage of the pipeline.

6. A processor operable to execute, under a pipeline system, an instruction sequentially issued according to a program included in an instruction set, the processor comprising:
a fetch circuit operable to fetch the instruction;
a register file including a plurality of registers;
a forwarding selector;
a processing execution circuit; and
a processor control circuit operable to control the processing execution circuit on the basis of the instruction fetched,
wherein the instruction set includes a register store instruction and a register reference instruction,
wherein the register store instruction is an instruction to store the result that the processing execution circuit has executed processing specified by the instruction concerned, into a register specified by a destination operand of the instruction concerned among the registers included in the register file,
wherein the register reference instruction is an instruction which makes the processing execution circuit execute processing specified by the instruction concerned, with reference to data stored in a register specified by a source operand of the instruction concerned among the registers included in the register file,
wherein a part or all of the register reference instructions include a field to specify whether to prohibit or to permit forwarding in an instruction code,
wherein the processor control circuit comprises:
an instruction decoder operable to decode the fetched instruction;
a plurality of pipeline registers operable to hold a decoded result by the instruction decoder; and
a forwarding control circuit,
wherein the instruction decoder decodes the fetched instruction and outputs an execution code of the instruction, a destination operand code to specify a destination register when the instruction is the register store instruction, a source operand code to specify a source register when the instruction is the register reference instruction, and a decoded result of the field concerned when the instruction is a register reference instruction including a field to specify whether to prohibit or to permit the forwarding in an instruction code,
wherein the pipeline registers hold the destination operand code for every pipeline stage, and
wherein, on the basis of a decoded result of a field to specify whether to prohibit or to permit the forwarding, when the forwarding is prohibited, the forwarding control circuit controls the forwarding selector to read a value of the register specified by the source operand code from the register file and to supply it to the processing execution circuit, and when the forwarding is permitted, the forwarding control circuit compares the destination operand code held in the pipeline registers for every pipeline stage with the source operand code, and controls the forwarding selector to execute the forwarding from a pipeline stage in agreement to the processing execution circuit.

7. The processor according to claim 6,
wherein the processor is provided with N pieces of the processing execution circuit (N is an arbitrary natural number), and can execute in parallel an instruction word including the N instructions included in the instruction set in one word by the corresponding processing execution circuit,
wherein M processing execution circuits out of the N processing execution circuits (M is an arbitrary natural number equal to or smaller than N) are coupled with forwarding selectors of the number corresponding to each input number,
wherein the instruction decoder decodes in parallel the N instructions included in the fetched instruction word and outputs the corresponding decoded result to each of the N processing execution circuits, and the decoded result corresponding to the M processing execution circuits includes the decoded result of the field to specify whether to prohibit or to permit the forwarding,
wherein the processor control circuit is provided with M forwarding control circuits corresponding to the M processing execution circuits, and
wherein each of the M forwarding control circuits executes the forwarding control to the corresponding processing execution circuit, on the basis of the decoded result of the field to specify whether to prohibit or to permit the forwarding.

8. The processor according to claim 7,
wherein the processor control circuit holds the destination operand code corresponding to each of the N processing execution circuits in the pipeline registers for every pipeline stage,
wherein the processor control circuit is provided with M forwarding control circuits corresponding to the M processing execution circuits, and
wherein, on the basis of a decoded result of a field to specify whether to prohibit or to permit the forwarding, when the forwarding is prohibited, each of the M forwarding control circuits controls one or more forwarding selectors coupled to the corresponding processing execution circuit to read a value of the register specified by the source operand code respectively corresponding to the one or more forwarding selectors from the register file and to supply it to the processing execution circuit concerned, and when the forwarding is permitted, each of the M forwarding control circuits compares the destination operand code corresponding to each of the N processing execution circuits held for every pipeline stage at the pipeline registers with the source operand code corresponding to the one or more forwarding selectors, respectively, and controls the forwarding selector concerned to execute the forwarding from a pipeline stage in agreement to the processing execution circuit.

9. The processor according to claim 6,
wherein, in place of or in addition to the part or all of the register reference instructions, a part or all of the register reference instructions include, in an instruction code, a field to specify a forwarding source to indicate whether to prohibit the forwarding or to permit the forwarding from which stage of the pipeline,
wherein, when the fetched instruction is a register reference instruction including a field to prohibit the forwarding or to specify the forwarding source in an instruction code, the instruction decoder further outputs the decoded result of the field concerned, and
wherein, on the basis of the decoded result concerned, when the forwarding is prohibited, the forwarding control circuit controls the forwarding selector to read a value of the register specified by the source operand code from the register file and to supply it to the processing execution circuit, and when the forwarding source is specified, the forwarding control circuit compares the destination operand code held in the specified pipeline stage of the pipeline registers with the source operand code, and controls the forwarding selector to execute the forwarding from a pipeline register in agreement to the processing execution circuit.

10. The processor according to claim 9,
wherein the processor is provided with N pieces of the processing execution circuit (N is an arbitrary natural number), and can execute in parallel an instruction word including the N instructions included in the instruction set in one word by the corresponding processing execution circuit,
wherein M processing execution circuits out of the N processing execution circuits (M is an arbitrary natural number equal to or smaller than N) are coupled with forwarding selectors of the number corresponding to each input number,
wherein the instruction decoder decodes in parallel the N instructions included in the fetched instruction word, and outputs the decoded result corresponding to each of the N processing execution circuits, and the decoded result corresponding to the M processing execution circuits includes at least one of the decoded result of the field to specify whether to prohibit or to permit the forwarding and the decoded result of the field to prohibit the forwarding or to specify the forwarding source,
wherein the processor control circuit is provided with M forwarding control circuits corresponding to the M processing execution circuits, and
wherein each of the M forwarding control circuits executes the forwarding control to the corresponding processing execution circuit on the basis of the decoded result.

11. The processor according to claim 10,
wherein the processor control circuit holds the destination operand code corresponding to each of the N processing execution circuits in the pipeline registers for every pipeline stage,
wherein the processor control circuit is provided with M forwarding control circuits corresponding to the M processing execution circuits, and
wherein, on the basis of the decoded result of the field to prohibit or to permit the forwarding or to specify the forwarding source, when the forwarding is prohibited, each of the M forwarding control circuits controls one or more forwarding selectors coupled to the corresponding processing execution circuit to read a value of the register specified by the source operand code respectively corresponding to the one or more forwarding selectors from the register file and to supply it to the processing execution circuit concerned; when the forwarding is permitted, each of the M forwarding control circuits compares the destination operand code corresponding to each of the N processing execution circuits held in the pipeline registers for every pipeline stage with the source operand code corresponding to the one or more forwarding selectors, respectively, and controls the forwarding selector concerned to execute the forwarding from a pipeline register in agreement to the processing execution circuit; and when the forwarding source is specified, each of the M forwarding control circuits compares the destination operand code held in the pipeline register of the pipeline stage of which the forwarding source is specified, among the destination operand codes held for every pipeline stage corresponding to the N processing execution circuits, with the source operand code corresponding to the forwarding selector, respectively, and controls the forwarding selector concerned to execute the forwarding from a pipeline register in agreement to the processing execution circuit.

12. The processor according to claim 6,
wherein the processor is formed over a single semiconductor substrate.

13. A program code translator operable to convert a program code of a program comprised of a plurality of instructions included in an instruction set and executed by a processor,
wherein the processor comprises a register file comprised of a plurality of registers; and a processing execution circuit, and the processor is comprised of a pipeline including a register read step which refers to the register file, and a write back step which writes a value into the register file,
wherein the instruction set includes a register reference instruction, a register store instruction, and a register move instruction,
wherein the register reference instruction is an instruction to refer to a value stored in a register specified by a source operand of the instruction concerned, among a plurality of registers included in the register file in the register read step, and to make the processor execute processing specified by the instruction concerned,
wherein the register store instruction is an instruction to store the result that the processor has executed the processing specified by the instruction concerned into a register specified by a destination operand of the instruction concerned among a plurality of registers included in the register file, in the write back step delayed from the register read step by a delaying amount specified in terms of the number of stages of the pipeline,
wherein the register move instruction is an instruction to read a value stored in a register specified by a source operand of the instruction concerned among a plurality of registers included in the register file in the register read step, and to write the value into a register specified by a destination operand of the instruction concerned in the write back step,
wherein all or a part of the register reference instructions further include in an operand a forwarding invalid flag to specify whether to prohibit or to permit forwarding; when the forwarding is prohibited by the forwarding invalid flag, the processor controls the register read step to refer the register file; and when the forwarding is permitted by the forwarding invalid flag, the processor executes the register store instruction or the register move instruction and refers to a value stored into a register specified by the source operand from an intermediate stage of a pipeline which writes data into a register specified by the destination operand, and
wherein the program code translator searches for a register move instruction from the program code comprised of a plurality of instructions included in the instruction set, extracts a register store instruction to specify by a destination operand a register specified by a source operand of the register move instruction found by the search, and replaces the subsequent register reference instruction which specifies by a source operand the register specified by the destination operand of the register move instruction found by the search, with the register reference instruction which has specified to prohibit the forwarding based on a forwarding invalid flag, when executed in an execution step within the delaying amount from the register store instruction.

14. The program code translator according to claim 13,
wherein the program code translator replaces the subsequent register reference instruction which specifies by a source operand the register specified by the destination operand of the register move instruction found by the search, with a register reference instruction which has specified to permit the forwarding based on a forwarding invalid flag, when executed in an execution step behind the delaying amount from the register store instruction, after determining whether it is possible to be moved to an execution step to be executed within the delaying amount and having been moved when it is possible.

15. The program code translator according to claim 14,
wherein the program code translator replaces all the subsequent register reference instructions which specify by a source operand the register specified by the destination operand of the register move instruction found by the search, with the register reference instruction which has specified to prohibit the forwarding based on a forwarding invalid flag, when executed in an execution step behind the delaying amount from the register store instruction, after determining whether it is possible to be moved to an execution step to be executed within the delaying amount and having been moved when it is possible, and
wherein the program code translator deletes the register move instruction found by the search from the program when all the register reference instructions have been moved to the execution step to be executed within the delaying amount.

16. The program code translator according to claim 13,
wherein the processor is provided with N pieces of the processing execution circuit (N is an arbitrary natural number), and can execute in parallel an instruction word including the N instructions included in the instruction set in one word by the corresponding processing execution circuit.

17. The program code translator according to claim 13,
wherein the program code translator generates the program code comprised of a plurality of instructions included in the instruction set, from a program described in a high level language.

18. Software operable to function as the program code translator described in claim 13 when executed by a computer.
